(19) United States
(12) Patent Application Publication
(10) Pub. No.: US 2013/0128275 A1
(43) Pub. Date: May 23, 2013

(54) INTERFERENCE OPTICAL SYSTEM, SUBSTRATE PROCESSING APPARATUS, AND MEASURING METHOD

(71) Applicant: TOKYO ELECTRON LIMITED, Tokyo (JP)

(72) Inventors: Tatsuo MATSUDO, Nirasaki City (JP); Kenji NAGAI, Kurokawa-gun (JP)

(73) Assignee: TOKYO ELECTRON LIMITED, Tokyo (JP)

(21) Appl. No.: 13/665,956

(22) Filed: Nov. 1, 2012

Related U.S. Application Data
(60) Provisional application No. 61/560,947, filed on Nov. 17, 2011.

(30) Foreign Application Priority Data
Nov. 1, 2011 (JP) 2011-240304

(51) Int. Cl. G01B 11/06; G01K 11/12

(52) U.S. Cl. CPC G01B 11/06; G01K 11/125
USPC 356/451; 356/43

(57) ABSTRACT

The interference optical system includes a light source, a collimator, a light-receiving element, a tunable filter, and a calculation apparatus. The collimator emits measuring light from the light source to a first main surface of the object, and receives reflected light from the first main surface and a second main surface. The light-receiving element acquires an intensity of light from the collimator. The tunable filter sweeps a wavelength of the light incident to the light-receiving element. The calculation apparatus measures an interference intensity distribution that has wavelength dependence and is an intensity distribution of the reflected light from the first main surface and the second main surface, and measures the thickness or the temperature of the object based on a waveform obtained by Fourier transforming the interference intensity distribution.

### CROSS-REFERENCE TO RELATED PATENT APPLICATIONS

This application claims the benefit of Japanese Patent Application No. 2011-240304 filed on Nov. 1, 2011 in the Japan Patent Office and U.S. Patent Application Ser. No. 61/560,947 filed on Nov. 17, 2011 in the United States Patent and Trademark Office, the disclosure of which are incorporated herein in their entireties by reference.

### BACKGROUND OF THE INVENTION

1. Field of the Invention

The present invention relates to an interference optical system, a substrate processing apparatus, and a measuring method.

2. Description of the Related Art

Patent reference 1 discloses a kind of interference optical system that emits light from a light source to an object to be measure and detects interference light from a surface and a rear surface of the object by using a light-receiving unit, and measures a film thickness through a frequency analysis (frequency domain optical interference method) by using a spectrum of interference light. As the light-receiving unit, a line sensor, such as a charge-coupled device (CCD) in which a plurality of light-receiving elements are arranged, or a silicon photodiode array in which a plurality of silicon photodiodes are arranged, may be used.

According to the frequency region optical interference method, a maximum optical path length that is measurable is proportional to a wavelength of the light source and the number of samplings, and inverse-proportional to a measured wavelength band. The number of samplings (a wavelength resolution, that is, the number of divided wavelengths within a wavelength range of a spectrometer) is defined by the number of light-receiving elements that are arranged, and thus, is a fixed value. Thus, if you want to increase a measurable film thickness, a wavelength of the light source needs to be increased, or a measured wavelength band needs to be reduced. However, even if the wavelength and the measured wavelength band are adjusted, in a case where, for example, a film is formed of Si, the measurable film thickness is limited to a few mm order, and it is difficult to increase the measurable film thickness to tens of mm order.

Thus, an interference optical system capable of easily changing an uppermost value of a measurable film thickness, a substrate processing apparatus, and a measuring method are necessary.
(Patent Reference 1) Japanese Laid-open Patent Publication No. 2009-139360

### SUMMARY OF THE INVENTION

According to an aspect of the present invention, there is provided an interference optical system for measuring a thickness or a temperature of an object which includes a first main surface and a second main surface opposite to the first main surface. The interference optical system may include: a light source, a collimator, a single light-receiving element, a sweeping unit, a spectrum acquisition unit, and a measuring unit. The light source may emit measuring light having a wavelength transmitting through the object. The collimator may be connected to the light source to emit the measuring light from the light source to the first main surface of the object, and receive reflected light from the first main surface and the second main surface. The single light-receiving element may receive the light from the collimator to obtain an intensity of the light. The sweeping unit may sweep a wavelength of the light incident to the light-receiving element. The spectrum acquisition unit may measure an interference intensity distribution that has wavelength dependence and is an intensity distribution of the reflected light from the first main surface and the second main surface, by using the sweeping unit and the light-receiving element. The measuring unit may measure the thickness or the temperature of the object based on a waveform obtained by Fourier transforming the interference intensity distribution,

According to the above interference optical system, a wavelength of the light incident to the single light-receiving element is swept by the sweeping unit, and thus, the number of samplings may be arbitrarily adjusted. Therefore, by increasing the number of samplings within a measured wavelength range, an upper limit of a measurable film thickness may be increased greatly.

The sweeping unit may be a filter capable of changing the wavelength of the measuring light or the reflected light. The sweeping unit may control the wavelength of the measuring light or the reflected light by using a diffractive grating. The sweeping unit may change a wavelength of the light source. According to the above configuration, the wavelength of the light incident to the light-receiving element is changed.

The measuring unit may apply a window function to the interference intensity distribution, in which the window function has wavelength dependence and is a bell-shaped window function which has a peak at a central wavelength determined by a wavelength sweep range of the sweeping unit and which is gradually decreased as being is apart from the central wavelength. The measuring unit may measure the thickness or the temperature of the object based on a waveform obtained by Fourier transforming the interference intensity distribution after applying the window function. According to the above configuration, the waveform before the Fourier transformation may be adjusted to be suitable for the Fourier transformation, and thus, a peak of the waveform after the Fourier transformation may have an appropriate width. Thus, accuracy of detecting the peak location may be improved.

The measuring unit may normalize the interference intensity distribution by using an intensity distribution of the measuring light from the light source, which is acquired in advance, before applying the window function. Therefore, even when an intensity distribution of the measuring light is asymmetrical or distorted, the waveform before the Fourier transformation may be adjusted to be suitable for the Fourier transformation.

The window function may be a Gaussian function, Lorentz function, and a combined function of the Gaussian function and the Lorentz function. These functions are bell-shape window functions which are gradually decreased as being apart from central wavelength.

According to another aspect of the present invention, there is provided a substrate processing apparatus including: an interference optical system. The interference optical system includes a light source, a collimator, a single light-receiving element, a sweeping unit, a spectrum acquisition unit, and a measuring unit. The light source may emit measuring light having a wavelength transmitting through the object. The collimator may be connected to the light source to emit the measuring light from the light source to the first main surface of the object, and receive reflected light from the first main surface and the second main surface. The single light-receiving element may receive the light from the collimator to obtain an intensity of the light. The sweeping unit may sweep a wavelength of the light incident to the light-receiving element. The spectrum acquisition unit may measure an interference intensity distribution that has wavelength dependence and is an intensity distribution of the reflected light from the first main surface and the second main surface by using the sweeping unit and the light-receiving element. The measuring unit may measure the thickness or the is temperature of the object based on a waveform obtained by Fourier transforming the interference intensity distribution.

According to another aspect of the present invention, there is provided a measuring method for measuring a thickness or a temperature of an object which includes a first main surface and a second main surface opposite to the first main surface, by using an interference optical system. The interference optical system includes a light source, a collimator, a single light-receiving element, and a sweeping unit. The light source may emit measuring light having a wavelength transmitting through the object. The collimator may be connected to the light source to emit the measuring light from the light source to the first main surface of the object, and receive reflected light from the first main surface and the second main surface. The single light-receiving element may receive the light from the collimator to obtain an intensity of the light. The sweeping unit may sweep a wavelength of the light incident to the light-receiving element. The measuring method includes: a spectrum acquiring operation and a measuring operation. In the spectrum acquiring operation, a wavelength of the light incident to the light-receiving element may be swept by the sweeping unit and an interference intensity distribution that has wavelength dependence and is an intensity distribution of the reflected light from the first main surface and the second main surface is measured, and in the measuring operation, the thickness or the temperature of the object may be measured based on a waveform obtained by Fourier transforming the interference intensity distribution.

### BRIEF DESCRIPTION OF THE DRAWINGS

The above and other features and advantages of the present invention will become more apparent by describing in detail exemplary embodiments thereof with reference to the attached drawings in which:

FIG. 1 is a view schematically showing an interference optical system according to an embodiment of the present invention;

FIG. 2 is a functional block diagram of a calculation apparatus shown in FIG. 1;

FIG. 3 is a graph showing a relation between an applied voltage and a transmission wavelength in a wavelength conversion filter;

FIG. 4A is a graph showing time sampling of a voltage;

FIG. 4B is a graph showing time sampling of a light intensity;

FIG. 4C is a graph showing a relation between the light intensity and the voltage;

FIG. 5 is a diagram showing a wavelength-intensity spectrum when using a wavelength conversion filter;

FIG. 6 is schematic diagram of an incident light spectrum and a reflected light spectrum;

FIG. 7 is a schematic diagram describing Fourier transformation of a reflected light spectrum;

FIG. 8 is a schematic diagram describing a maximum measurable thickness;

FIG. 9 is schematic diagrams describing a minimum spatial resolution, wherein (a) shows a spectrum representing an intensity distribution according to location and (b) shows a spectrum representing an intensity distribution according to a wave number;

FIG. 10A shows an example of a reflected light spectrum;

FIG. 10B is a peak waveform after performing a fast Fourier-transformation (FFT) on the reflected light spectrum shown in FIG. 10A;

FIG. 11A shows an example of a reflected light spectrum;

FIG. 11B is a peak waveform after performing an FFT on the reflected light spectrum shown in FIG. 11A:

FIG. 12A shows an example of a reflected light spectrum;

FIG. 12B is a peak waveform after performing an FFT on the reflected light spectrum shown in FIG. 12A;

FIGS. 13A and 13B are graphs showing examples of Gaussian function;

FIG. 13C is a schematic diagram describing a Gaussian function for calculating a center appropriately;

FIG. 14A is a diagram showing an example of a reflected light spectrum;

FIG. 14B is a diagram showing an example of a Gaussian function;

FIG. 14C is a diagram showing a spectrum obtained after adjusting the reflected light spectrum of FIG. 14A by using the Gaussian function of FIG. 14B;

FIG. 15A is a diagram showing an example of a reflected light spectrum;

FIG. 15B is a diagram showing a waveform after performing an FFT;

FIG. 15C is a partially enlarged view of the waveform of FIG. 15B;

FIG. 16A is a diagram showing an example of a reflected light spectrum;

FIG. 16B is a diagram showing a waveform after performing an FFT;

FIG. 16C is a partially enlarged view of the waveform of FIG. 16B;

FIG. 17 is a graph showing a relation between a half width at half maximum of a light source and a width of a waveform obtained after a FFT;

FIG. 18 is a flowchart describing operations of a calculation apparatus;

FIGS. 19A, 19B, and 19C are graphs for describing operations of a calculation apparatus, wherein FIG. 19A shows a light source spectrum representing an intensity distribution depending on a wavelength, FIG. 19B shows a reflected light spectrum representing an intensity distribution depending on a wavelength, and FIG. 19C shows a reflected light spectrum representing an intensity distribution depending on a reciprocal number of a wavelength;

FIGS. 20A through 20C are graphs for describing operations of a calculation apparatus, wherein FIG. 20A shows a spectrum after linearly interpolating the reflected light spectrum representing an intensity distribution depending on a reciprocal number of a wavelength, FIG. 20B shows a spectrum after performing a FFT of the reflected light spectrum of FIG. 20A, and FIG. 20C is a partially enlarged view of the spectrum of FIG. 20B;

FIG. 21 is a diagram showing an example of temperature correction data;

FIG. 22A is a diagram showing an example of a spectrum of measuring light of the light source;

FIG. 22B is a diagram showing an example of a reflected light spectrum;

FIG. 23A is a diagram showing an example of a reflectivity;

FIG. 23B is a diagram showing an example of a Gaussian function;

FIG. 23C is a diagram showing an example of a reflected light spectrum after adjustment;

FIG. 24 is a functional block diagram showing another example of an interference optical system;

FIG. 25 is a functional block diagram showing another example of an interference 51 optical system;

FIG. 26 is a functional block diagram showing another example of an interference optical system;

FIG. 27 is a diagram showing a substrate processing apparatus according to an embodiment of the present invention;

FIG. 28A is a diagram showing a measuring result of a reflected light spectrum:

FIG. 28B is a diagram showing an example of a Gaussian function;

FIG. 28C is a diagram showing a reflected light spectrum after adjustment;

FIG. 29A is a diagram showing a peak waveform after a FFT without an adjustment;

FIG. 29B is a diagram showing an example of a Gaussian function after the FFT with an adjustment; and

### DETAILED DESCRIPTION OF THE INVENTION

Hereinafter, the present invention will be described in detail by explaining exemplary embodiments of the invention with reference to the attached drawings. Like reference numerals in the drawings denote like elements.

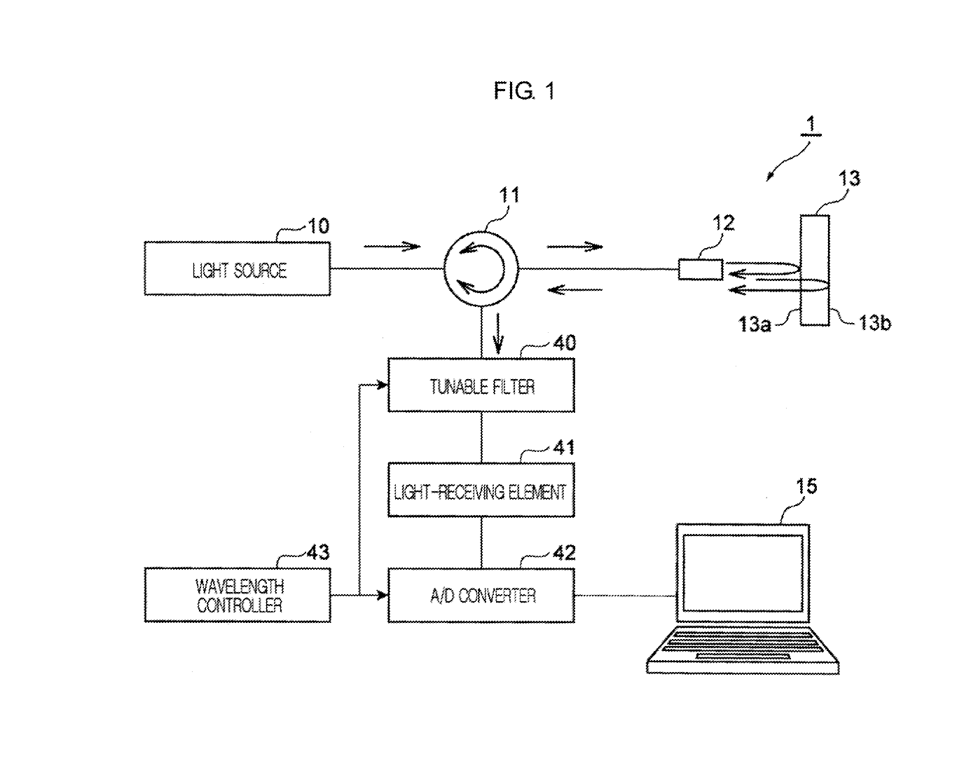

FIG. 1 is a configuration view for showing an example of an interference optical system 1 according to an embodiment of the present invention. As shown in FIG. 1, the interference optical system is a system for measuring a temperature of the object. The interference optical system 1 measures a temperature by using optical interference.

The interference optical system 1 includes a light source 10, an optical circulator 11, a collimator 12, a tunable filter 40, a light-receiving element 41, an analog/digital (A/D) converter 42, a wavelength controller 43, and a calculation apparatus (measuring unit) 15. Also, connections to the light source 10, the optical circulator 11, the collimator 12, the tunable filter 40, and the light-receiving element 41 are performed respectively by using optical fiber cables.

The light source 10 generates measuring light having a wavelength that transmits through an object 13. The light source 10 may be a super luminescent diode (SLD). In addition, the object 13 is formed as, for example, a plate shape having a first main surface 13a and a second main surface 13b opposite to the first main surface 13a. Hereinafter, the first main surface 13a will be referred to as a surface 13a and the second main surface 13b will be referred to as a rear surface 13b, if necessary. The object 13 that is to be measured may be, for example, silicon (Si), quartz (SiO₂), or sapphire (Al₂O₃). A refractive index of the Si is 3.4 when a wavelength is 4 μm. A refractive index of the SiO₂ is 1.5 when a wavelength is 1 μm. A refractive index of the Al₂O₃ is 1.8 when a wavelength is 1 μm.

The optical circulator 11 is connected to the light source 10, the collimator 12, and the tunable filter 40. The optical circulator 11 emits the measuring light generated by the light source 10 toward the collimator 12. The collimator 12 emits the measuring light toward the surface 13a of the object 13. The collimator 12 emits the measuring light that is adjusted to be parallel light. In addition, the collimator 12 receives light reflected from the object 13. The reflected light may include the light reflected from the rear surface 13b, as well as the light reflected from the surface 13a. The collimator 12 emits the reflected light toward the optical circulator 11. The optical circulator 11 emits the reflected light to the tunable filter 40.

The tunable filter 40 is a wavelength variable filter that may change a wavelength of incident light. The tunable filter 40 may use any kind of filter types, such as a Fabry-Perot type, a diffraction grating type, an interference filter type, an acousto-optic type, and the like, provided that a wavelength of the light transmitted through the filter may be controlled by controlling an applied voltage or an applied frequency. The applied voltage or the applied frequency is controlled by the wavelength controller 43 that will be described below. The tunable filter 40 emits the transmitted light to the light-receiving element 41.

The light-receiving element 41 is a device for detecting light, and outputs signals according to an intensity of light, for example. Herein, a single light-receiving element 41 is used. As the light-receiving element 41, a photodiode or a photomultiplier tube, for example, may be used. The light-receiving element 41 outputs an output signal to the A/D converter 42.

The A/D converter 42 converts an analog output signal from the light-receiving element 41 into a digital signal. The A/D conversion timing is controlled by the wavelength controller 43 that will be described below. The A/D converter 42 outputs the digital signal to the calculation apparatus 15.

The wavelength controller 43 is connected to the tunable filter 40 to control the voltage applied to the tunable filter 40. Also, the wavelength controller 43 is connected to the A/D converter 42 so as to synchronize the timing for controlling the applied voltage and the A/D conversion timing.

A reflected light spectrum (interference intensity distribution) is measured by the tunable filter 40, the light-receiving element 41, the A/D converter 42, and the wavelength controller 43 (that is, the above components serve as spectrum acquisition units). The reflected light spectrum represents an intensity distribution according to the wavelength or frequency of the reflected light. The digital signal output from the A/D converter 42 to the calculation apparatus 15 becomes the reflected light spectrum.

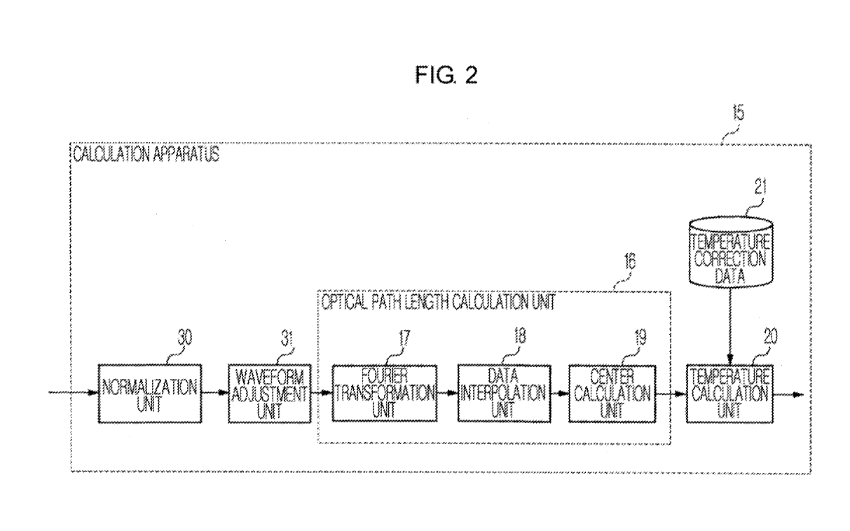

The calculation apparatus 15 measures a film thickness or a temperature of the object 13 based on the reflected light spectrum. FIG. 2 is a functional block diagram of the calculation apparatus 15. As shown in FIG. 2, the calculation apparatus 15 includes a normalization unit 30, a waveform adjustment unit 31, an optical path length calculation unit 16, a temperature calculation unit 20, and temperature correction data 21.

The normalization unit 30 normalizes a waveform of the reflected light spectrum by using a spectrum of the measuring light from the light source 10, which is acquired in advance, For example, in a case where a profile of the light source spectrum (measuring light spectrum) of the light source 10 is distorted or asymmetrical, a signal after performing processes that will be described below is also distorted, and accordingly, the measuring may not be performed precisely. Thus, the reflected light spectrum is divided by the light source spectrum to be normalized. That is, it becomes a waveform of reflectivity. The normalization unit 30 outputs the calculated waveform to the waveform adjustment unit 31.

The waveform adjustment unit 31 adjusts the waveform by using a window function depending on the wavelength. The window function is a bell-shaped function which has a peak at a central wavelength determined by a wavelength sweep range of a sweeping unit and is gradually decreased as being apart from the central wavelength. The central wavelength may be a central value within the wavelength sweep range, for example. The window function may be a Gaussian function, Lorentz function, and a combined function of the Gaussian function and the Lorentz function. The waveform adjustment unit 31 applies the window function with respect to the waveform of the reflectivity output from the normalization unit 30. The waveform adjustment unit 31 outputs the waveform after the adjustment to the optical path length calculation unit 16.

The optical path length calculation unit 16 includes a Fourier-transformation unit 17, a data interpolation unit 18, and a center calculation unit 19. The Fourier-transformation unit 17 transforms the reflected light spectrum in a fast Fourier transformation (FFT) method. For example, in a Fourier-transformation in time domain, the reflected light spectrum representing the intensity distribution depending on the frequency (the frequency per unit time) is transformed into a reflected light spectrum representing intensity distribution depending on time. Also, for example, in a Fourier transformation in spatial domain, the reflected light spectrum representing the intensity distribution depending on a spatial frequency (the frequency per unit length) is transformed into a reflected light spectrum representing an intensity distribution depending on a location. The data interpolation unit 18 interpolates data points within a range including a predetermined peak value of the reflected light spectrum after the Fourier transformation. The center calculation unit 19 calculates a center position of the predetermined peak value of the reflected light spectrum after the Fourier transformation. The optical path length calculation unit 16 calculates an optical path length based on the center position.

The temperature calculation unit 20 calculates a temperature of the object 13 based on the optical path length. The temperature calculation unit 20 calculates the temperature of the object 13 with reference to temperature correction data 21. The temperature correction data 21 is data measured in advance, and represents relation between the temperature and the optical path length.

Also, the normalization unit 30 may not be necessary if the light source spectrum is included in the measured wavelength range. In this case, the waveform adjustment 51 unit 31 applies the window function with respect to the digital signal output by the A/D converter 42.

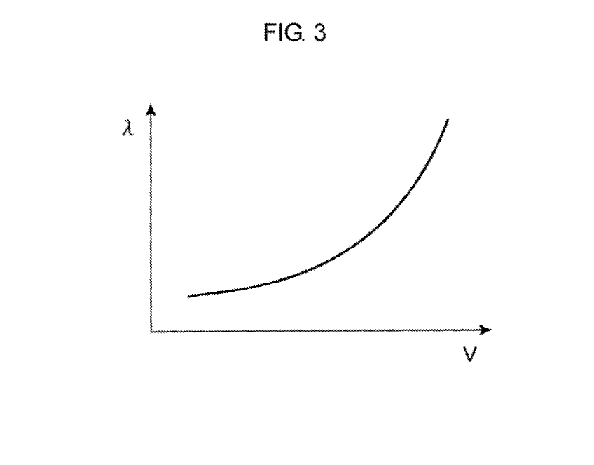

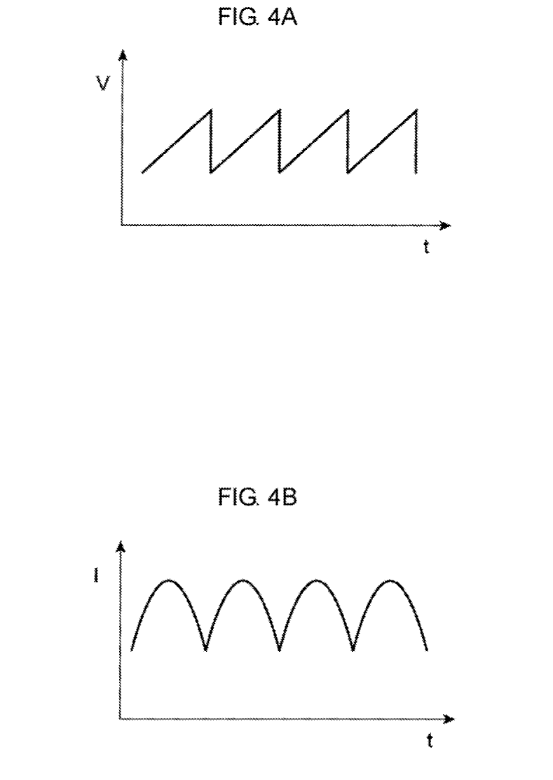

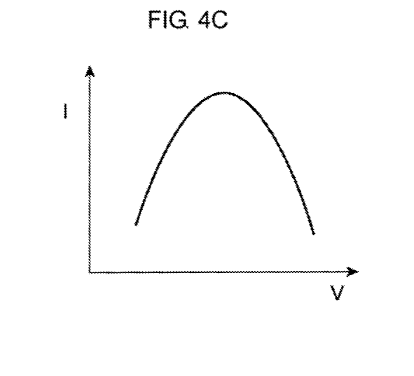

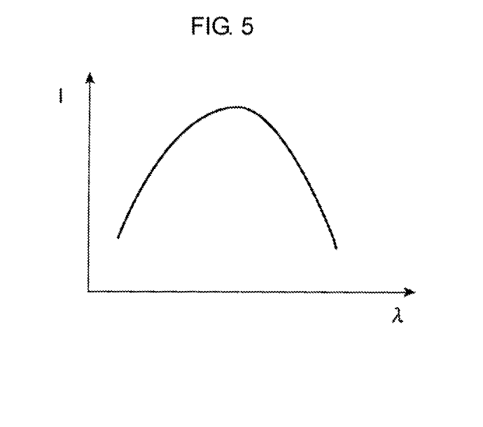

Hereinafter, by using the tunable filter 40 and the A/D converter 42, operating principles of the wavelength sweep will be described in detail below. Here, a case where the wavelength is changed by using the applied voltage will be described for the convenience of comprehension. FIG. 3 is a graph showing a relation between the applied voltage and the transmission wavelength of the tunable filter 40. As shown in FIG. 3, the relation between the applied voltage and the wavelength of the transmitted light is acquired in advance. Next, as shown in FIGS. 4A, 4B, and 4C, the time sampling is performed in the A/D converter 42. FIG. 4A is a graph showing a time sampling result with respect to a voltage V, and FIG. 4B is a graph showing a time sampling result with respect to a light intensity I. Based on the graphs of FIGS. 4A and 4B, the relation between the voltage and the light intensity may be calculated as shown in FIG. 4C. Otherwise, the graph of FIG. 4C may be directly plotted from the measuring results. A spectrum of the wavelength and the intensity may be acquired by using the graphs shown in FIG. 3 and FIG. 4C, FIG. 5 shows an example of a light spectrum. Also, the graph shown in FIG. 5 may be directly plotted from the measuring result. As described with reference to FIGS. 3 through 5, the light spectrum may be obtained even with a single light-receiving element, by using the tunable filter 40.

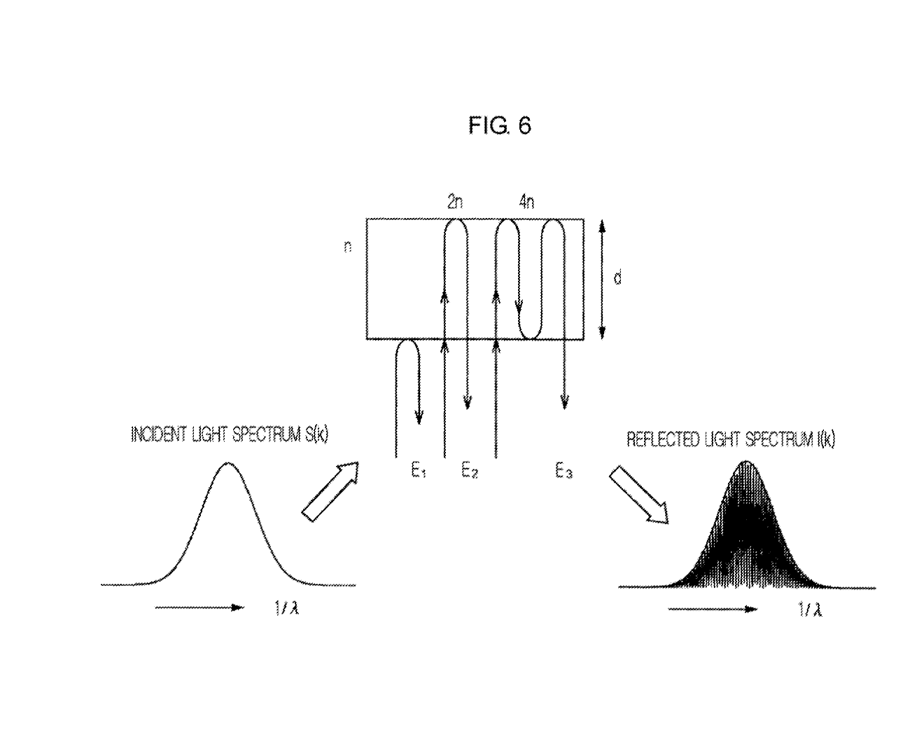

By using the interference optical system 1 having the above described configuration, the temperature of the object 13 is measured by using the optical interference between the surface 13a and the rear surface 13b of the object 13 (FFT frequency domain method). Hereinafter, principles of the optical interference will be described below. FIG. 6 is a schematic diagram describing an incident light spectrum and a reflected light spectrum. As shown in FIG. 6, the measuring light emitted from the light source 10 is the incident light. An intensity S(k) of the incident light spectrum depends on a spatial frequency 1/A (the frequency of vibrations per unit length). If it is assumed that the wavelength of the light source 10 is A, a wave number k is 2π/λ, It is assumed that a thickness of the object 13 is d, a refractive index of the object 13 is n, and a reflectivity of the object 13 is R. Reflected light E is obtained by overlapping a plurality of reflected light components. For example, E₁ is a reflected light component is from the surface 13a, and E₂ is a reflected light component from the rear surface 13b. In addition, E₃ is a reflected light component reflected once from the surface 13a and twice from the rear surface 13b. Other reflected light components after E₄ are omitted here, By overlapping the plurality of reflected light components, an intensity I(k) of the reflected light spectrum is obtained. The intensity I(k) of the reflected light spectrum and the intensity S(k) of the incident light spectrum have a relationship as shown in the following equation (1).

I(k)∝{2R(1−R)−2R(1−2R)cos(2nkd)−2R² cos(4nkd)}S(k) (1)

In the equation (1), a second term is a term relating to interference between a surface and a rear surface, and a third term is a term relating to multiple interference between a surface and a rear surface. When the above equation (1) is Fourier transformed, a reflected light spectrum depending on location may be obtained.

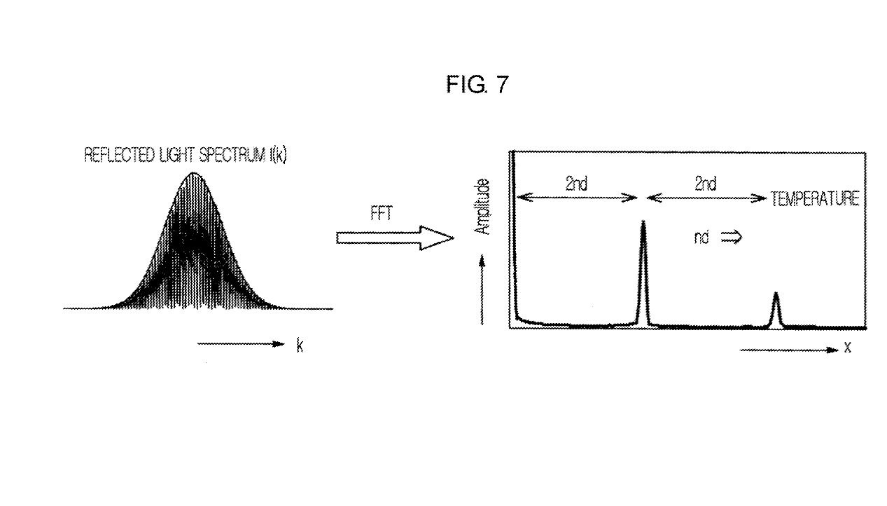

FIG. 7 is a schematic diagram for describing Fourier transformation of the intensity I(k) of the reflected light spectrum. As shown in FIG. 7, by the spatial domain Fourier transformation, the spatial frequency 1/A is transformed to a location x. The intensity I(k) of the reflected light spectrum that is transformed to the location x is as follows by performing Fourier transformation of the above equation (1).

I(x)=2R(1−R)·S(x)−R(1−R)·{S(x+2nd)+S(x−2nd)}−R²·{S(x+4nd)+S(x−4nd)}

As shown in the above equation (2), a peak shows at every 2nd. Here, 2nd is a optical path difference of the surface and the rear surfaces. That is, nd is an optical path length between the surface and the rear surface. As described above, the temperature may be calculated by specifying the optical path length nd from a relation between the optical path lengths nd and the temperature, which is measured in advance. In addition, in the above description, the spatial domain Fourier transformation is used; however, a time domain Fourier transformation can be used. When a frequency is v, the location x satisfies the following equation.

$$2 π \cdot v \cdot t = 2 π \cdot \frac{v}{c} \cdot ct = 2 π \cdot \frac{1}{λ} \cdot x$$

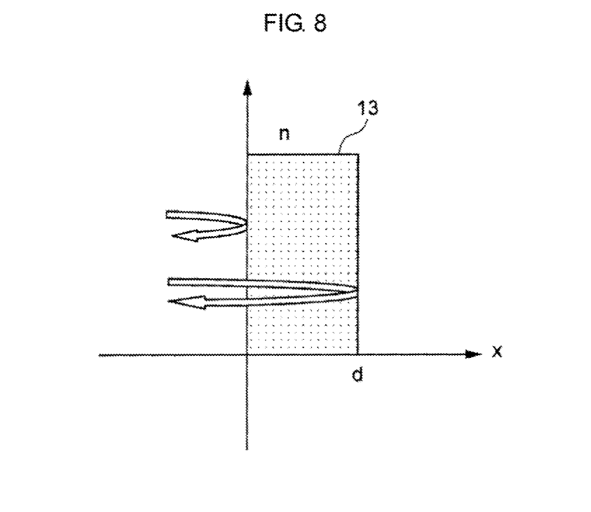

Next, a maximum thickness measurable by the interference optical system 1 (maximum measuring thickness) and data intervals after the Fourier transformation of the reflected light spectrum will be described. FIG. 8 is a schematic view for describing the reflected light. As shown in FIG. 8, a location of the surface of the object 13 having a thickness d and a refractive index n is 0 and a location of its the rear surface is represented on the x-axis. Here, a relation between time Δτ and an angular frequency Δω is represented by the following equation (3).

$$Δ τ = \frac{2 π}{Δ ω} \qquad ( 3 )$$

Here, the angular frequency ω and Δω is represented in terms of a wavelength λ and a half width at half maximum Δλ of the light source spectrum as follows.

$$ω = 2 π \cdot v = 2 π \frac{c}{λ} , Δ ω = - 2 π \cdot \frac{c}{{λ}^{2}} Δ λ \qquad ( 4 )$$

Since the frequency is a positive value, the following equation is satisfied.

$$Δ ω = - 2 π \cdot \frac{c}{{λ}^{2 }} \cdot Δ λ ⇒ 2 π \cdot \frac{c}{{λ}^{2 }} \cdot Δ λ \qquad ( 5 )$$

Therefore, the following equation is obtained.

$$Δ τ = \frac{2 π \cdot {λ}^{2}}{2 π \cdot c \cdot Δ λ} = \frac{{λ}^{2}}{c \cdot Δ λ} \qquad ( 6 )$$

When it is assumed that a distance for the light to move in the object 13 having the refractive index n (average refractive index (nₐᵥₑ)) for the time Δτ is Δx′, the distance Δx′ is represented in the following equation by using the above equations (3) and (5).

$$Δ {x}^{′} = \frac{c}{{n}_{ave}} \cdot Δ τ = \frac{{λ}^{2}}{{n}_{ave} \cdot Δ λ} \qquad ( 7 )$$

Since the light is transmitted through the surface and is reflected by the rear surface, the distance Δx′ is 2Δx in consideration of reciprocating distance. According to the above equation, data interval Δx in the reflected light spectrum after the FFT is represented by the following equation.

$$Δ x = \frac{c}{2 \cdot {n}_{ave }} \cdot Δ τ = \frac{{λ}^{2}}{2 \cdot {n}_{ave} \cdot Δ λ} \qquad ( 8 )$$

In the frequency region method, an real spectrum intensity I(k) is a discrete value of the number of samplings (Nₛ) sampled in a wavelength axis direction. Therefore, the data after the FFT becomes Nₛ/2 numbers of discrete pieces of data with an interval Δx. Therefore, a maximum optical thickness xₘₐₓ that is measurable can be represented by the following equation.

$${x}_{ma x} = \frac{{λ}^{2}}{2 {n}_{ave} \cdot Δ λ} \cdot \frac{{N}_{s}}{2} = \frac{{λ}^{2}}{4 {n}_{ave} \cdot Δ λ} \cdot {N}_{s} \qquad ( 9 )$$

This is a value when transforming to a real space coordinate, and the data of the spectrum after the FFT becomes 2nₐᵥₑ multiple of this value. Therefore, in the space after the FFT, the maximum measurable optical thickness Xₘₐₓ and the data interval ΔX can be represented by the following equations,

$$\begin{matrix}{X}_{ma x} = 2 \cdot {n}_{ave } \cdot {x}_{ma x} = \frac{{λ}^{2}}{2 \cdot Δ λ} \cdot {N}_{s} & ( 10 ) \\ Δ X = 2 \cdot {n}_{ave} \cdot Δ x = \frac{{λ}^{2}}{Δ λ} & ( 11 )\end{matrix}$$

The above equations are general equations that are not affected by a refractive index of a medium, and are determined only by conditions of the measuring system. In an actual measuring system, since Δλ can be considered as a minimum period of the FFT, herein, Δλ may be considered as a measurement wavelength range of the spectroscope or a wavelength scan range. When it is assumed that the wavelength span is Δw and a central wavelength of the spectroscope is λ₀, equations (10) and (11) are as follows

$$\begin{matrix}{X}_{ma x} = \frac{{λ}_{0}^{2}}{2 \cdot Δ w} \cdot {N}_{s} & ( 12 ) \\ Δ X = \frac{{λ}_{0}^{2}}{Δ w} & ( 13 )\end{matrix}$$

Here, the thickness of the object will be described by a concrete example. For example, in a case where a conventional CCD array is used, when it is assumed that the wavelength λ₀ is 1550 nm, the number of samplings Nₛ is 512, and the wavelength span Δw is 40 nm, the maximum measurable thickness Xₘₐₓ is calculated as 15.4 mm from the equation 12. When the above result is applied to the Si (n=3.65), the thickness d is 2.1 mm. Also, when the above result is applied to the Qz (n=1.47), the thickness d is 5.2 mm. Also, when the above result is applied to the sapphire (n=1.8), the thickness d is 4.3 mm.

According to the above equation 12, in order to measure the object having a greater thickness, the wavelength λ₀ may be increased or the wavelength span Δw may be reduced. However, there is a limitation in increasing the wavelength λ₀, that is, about 10% of the wavelength λ₀. Also, the wavelength span Δw may be reduced by one digit, to the maximum. Thus, it cannot measure tens of mm order thickness (when it is applied to the Si) by changing the above parameters.

Meanwhile, according to the equation (12), when the number of samplings N, is increased, thicker medium may be measured. In the conventional CCD sensor, the number of samplings Nₛ is the number of arrays, that is, a fixed value, and thus, it is not easy to change the number of samplings Nₛ. However, by sweeping the wavelength of the reflected light via the tunable filter 40 and detecting it via the single light-receiving element 41, the number of samplings N₂ in the wavelength axis direction may be set arbitrarily. For example, if the number of samplings Nₛ is set as 5000, the object having a thickness 10 times thicker than that of the object measurable by the CCD array in which 512 arrays are arranged may be measured.

Also, according to the equation (12), when the wavelength span Δw of the spectroscope is increased, the data interval ΔX after the FFT may be reduced. Accordingly, reducing of the data interval and increasing of the measurable thickness cannot be compatible with each other. The above equations are general equations that are not affected by the refractive index. Therefore, when transforming the above equations into real scale in the medium having the refractive index nₐᵥₑ, each the above equations is divided by 2nₐᵥₑ.

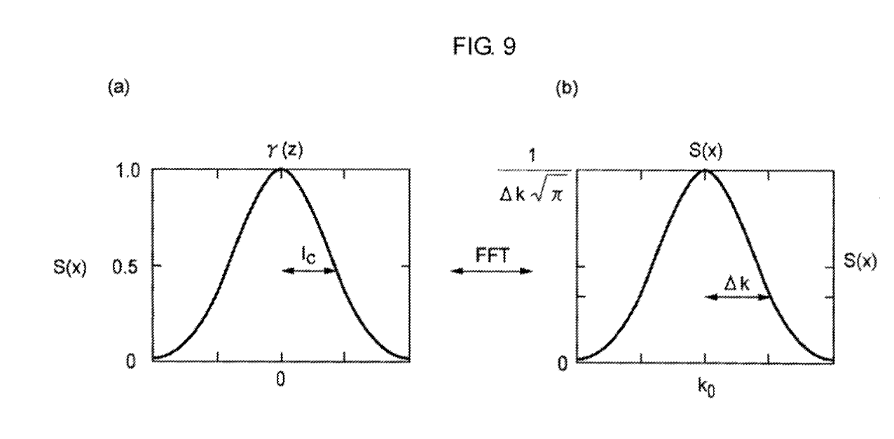

Here, a minimum spatial resolution will be described. (a) and (b) of FIG. 9 are schematic views for describing the minimum spatial resolution. (b) of FIG. 9 shows a spectrum representing the intensity distribution according to the wave number (k) of the light source, which may be approximated by a Gaussian function. An intensity S(k) of the spectrum shown in (b) of FIG. 9 can be represented by the following equation, when the wave number of the peak value is k₀, an intensity of the peak value 1/k·(π)^{1/2}, and a half width at half maximum is Δk.

$$S ( k ) = \frac{1}{Δ k \sqrt{π}} \cdot exp [ - {( \frac{k - {k}_{0}}{Δ k} )}^{2} ] = \frac{1}{Δ k \sqrt{π}} \cdot exp [ - {( \frac{k - {k}_{0}}{Δ {k}^{′}} )}^{2} \cdot ln 2 ] \qquad ( 14 )$$

In addition, the following equation is satisfied.

$$Δ k = \frac{Δ {k}^{′}}{\sqrt{ln 2}} \qquad ( 15 )$$

Also, a relation shown in the following equation is satisfied.

$$k = \frac{2 π}{λ} -> Δ k = \frac{2 π}{{λ}^{2}} \cdot Δ λ \qquad ( 16 )$$

The half width at half maximum Δk can be represented as the following equation by using the above equations (15) and (16).

$$Δ k = \frac{2 π \cdot Δ λ}{{λ}^{2} \sqrt{ln 2}} \qquad ( 17 )$$

Meanwhile, when the spectrum of (b) of FIG. 9 is transformed by the FFT, a spectrum of (a) of FIG. 9 is obtained. (a) of FIG. 9 shows a spectrum of a Gaussian function representing an intensity distribution according a location x. An intensity S(x) of the spectrum of (a) of FIG. 9 can be represented by the following equation, when a location of the peak value is 0 and the intensity of the peak is 1.

$$S ( x ) = exp ( - {x}^{2} \cdot Δ {k}^{2} ) = exp [ - {( \frac{x}{Δ {x}_{g}^{′}} )}^{2} \cdot ln 2 ] \qquad ( 18 )$$

In addition, the half width at half maximum Δk and a half width at half maximum Δx_{g} of S(x) have a relation represented by the following equation.

$$Δ {k}^{2} = \frac{ln 2}{Δ {x}_{g}^{2}} \qquad ( 19 )$$

When the half width at half maximum is I_{c}, the half width at half maximum Δx_{g} of S(x) can be represented by the following equation based on the above equation (19).

$$Δ {x}_{g} = \frac{\sqrt{ln 2}}{Δ k} = \frac{ln 2}{2 π} \cdot \frac{{λ}^{2}}{Δ λ} = \frac{{l}_{c}}{2} \qquad ( 20 )$$

The half width at half maximum I_{c} of the spectrum having the intensity S(x) becomes a coherence length. The minimum spatial resolution is I_{c} and is determined by the central wavelength and the half width at half maximum of the spectrum of the light source 10.

Next, a condition about the required number of samplings Nₛ will be derived based on the above described maximum measurable optical thickness xₘₐₓ. When a central wavelength of the light source 10 is λ₀, a half width at half maximum of the light source spectrum is Δλ, a wavelength span that is the wavelength sweep value of the tunable filter 40 is Δw, and a refractive index of the object 13 is n, the maximum measurable optical thickness xₘₐₓ is represented by the following equation, based on the above equation (9).

$${x}_{max} = \frac{{λ}_{0}^{2}}{4 \cdot n \cdot Δ w} \cdot {N}_{s} \qquad ( 21 )$$

Here, a maximum measurable thickness d and the maximum measurable optical thickness xₘₐₓ have to satisfy the following equation.

$$d < {x}_{max} = \frac{{λ}_{0}^{2}}{4 \cdot n \cdot Δ w} \cdot {N}_{s} \qquad ( 22 )$$

That is, the number of samplings (Nₛ) satisfying the following equation is necessary.

$${N}_{s} > \frac{4 \cdot n \cdot d \cdot Δ w}{{λ}_{0}^{2}} \qquad ( 23 )$$

For example, if the maximum measurable thickness d is 0.775 mm, the central wavelength λ₀ of the light source 10 is 1550 nm, and the refractive index n of the object 13 is 3.7, the following inequality is obtained.

$$\frac{Δ w}{{N}_{s}} < 2 \times {10}^{- 10} \qquad ( 24 )$$

Also, when the wavelength span Δw[m] is converted into Δw′[nm], the following inequality is obtained.

Δw′[nm]<0.2N, (25)

In the interference optical system 1, the sweep is performed in the wavelength span Δw′[nm] satisfying the relation represented in the equation (25) and the sampling is performed by the number of samplings Nₛ satisfying the relation represented in the equation (25). For example, when the wavelength span Δw′[nm] is 40 nm, the number of samplings Nₛ is greater than 200.

Next, a resolution that is necessary to measure the temperature of the object is described below. For example, when a Super Continuum (SC) light source having a wavelength band of 1200 nm to 2000 nm is used, the coherence length is 0.7 μm according to the equation (20). Since the coherence length is a half-value and half-width of the Gaussian function, the spatial resolution is about 1.4 μm that is twice of the coherence length. Meanwhile, according to the frequency domain method, the data interval ΔX after the FFT is 3.2 μm according to the equation (13), when the SC light source is used. Since the data interval Δx in the real space is obtained by dividing the data interval ΔX after the FFT by the refractive index n, for example, the data interval Δx of the Si (refractive index 3.6) is 0.9 μm and the data interval Δx of the Qz (refractive index 1.46) is 1.46 μm. Thus, the resolution of the Si is about 1 μm and the resolution of the Qz is about 2 μm.

In the field of temperature measuring, the resolution of about 0.1° C. is generally necessary. For example, if the thickness d of the Si is about 0.8 mm, a change in the optical path length 2nd has to be measured with an accuracy of 0.04 μm or less. If the data interval ΔX after the FFT is 0.04 μm and λ₀ is 1550 nm, the band width Δw of the light source needs to be 60 μm according to the equation (13), which is not practical.

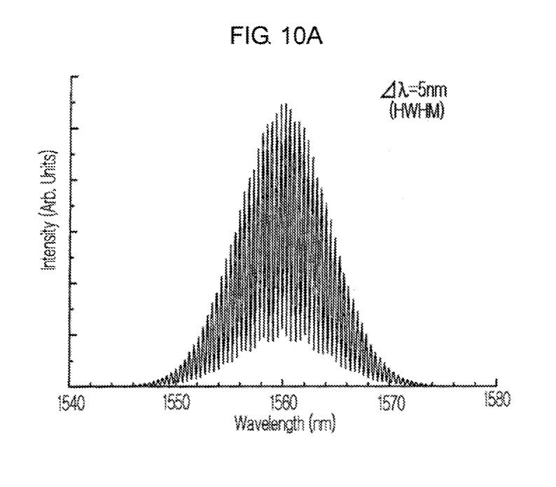

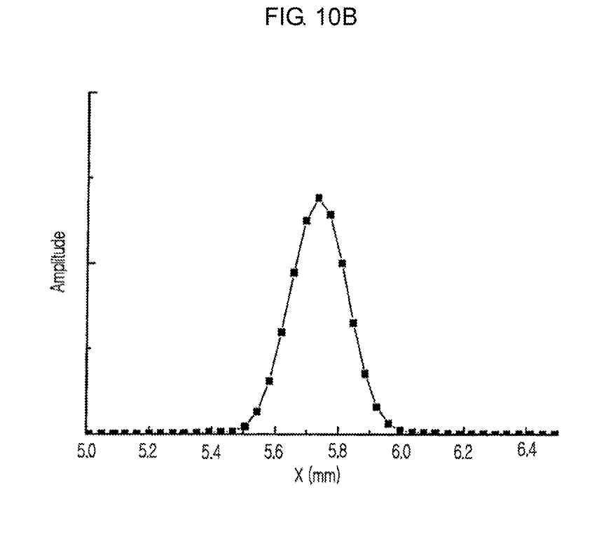

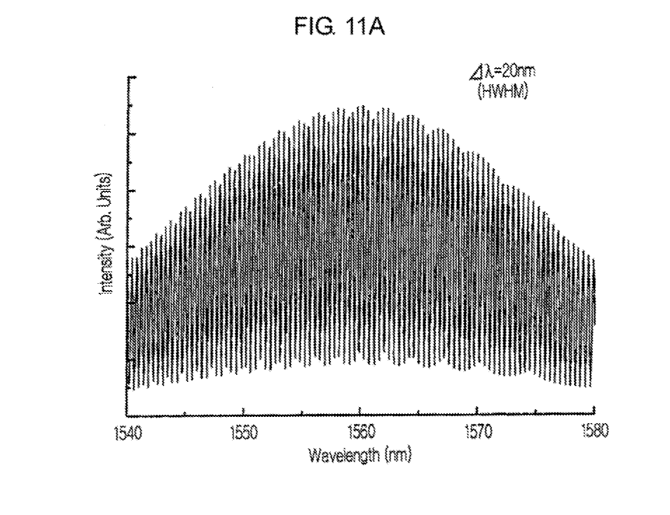

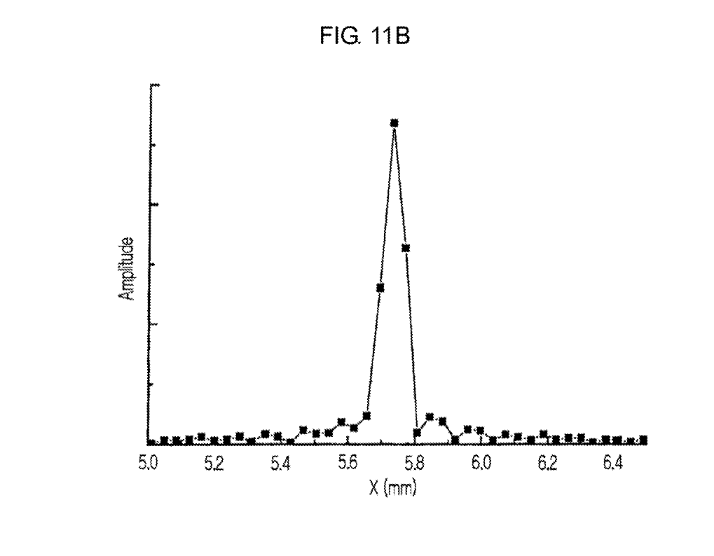

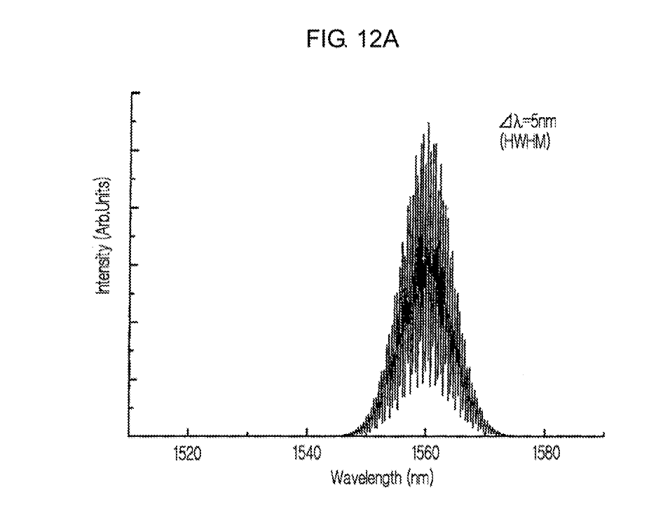

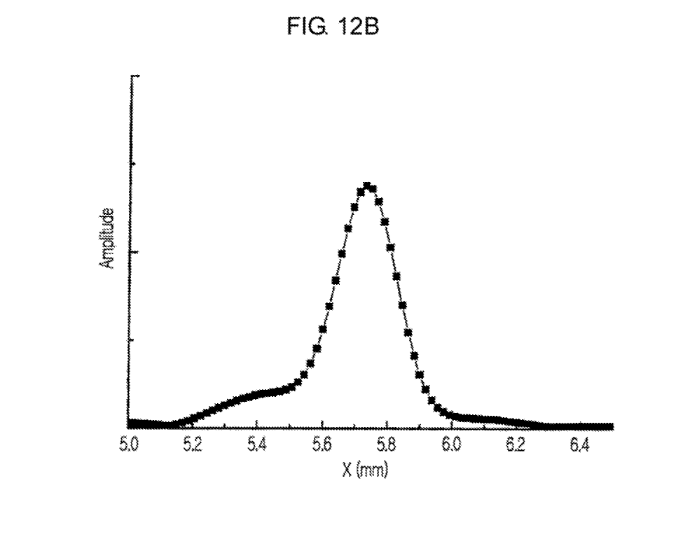

Therefore, in the method of measuring temperature by using the frequency domain method, in order to calculate the location of 2nd after the FFT accurately, a weighted center of the 2nd signal having some degree of width is calculated. The temperature change is detected based on the change in the location of the weighted centroid. Here, in order to calculate the weighted centroid with high accuracy, a signal shape of 2nd after the FFT is similar to the Gaussian function and at least three sampling points are necessary within 21. In addition, in order to make the signal shape of 2nd as the Gaussian function, the light source spectrum itself needs to be the Gaussian function. That is, the light source needs to be a Gaussian spectrum light source and a lower portion of the Gaussian function needs to be sufficiently included in a detection range. For example, the reflected light spectrum shown in FIG. 10A is an example of the spectrum that is similar to the Gaussian function. FIG. 108 shows a signal after FFT is performed on the reflected light spectrum shown in FIG. 10A. According to the above reflected light spectrum, the signal shape of the FFT is similar to that of the Gaussian function and the lower portion thereof is included in the detection range of 1540 to 1580 nm, and thus, the center location may be calculated appropriately. However, like a reflected light spectrum shown in FIG. 11A, if a lower portion of the spectrum largely exceeds the detection range, a peak becomes sharp like a signal shown in FIG. 11B and an accuracy of detecting the center location is lowered. Also, like a reflected light spectrum shown in FIG. 12A, if a center of the detection range and a central wavelength of the reflected light spectrum are different from each other, the signal may not be shaped as the Gaussian function as shown in FIG. 12B and the accuracy of detecting the center location is lowered.

Since it is difficult to design a Gaussian spectrum light source or an optical filter for an arbitrary Gaussian spectrum light source, data itself may be processed before performing the FFT. That is, after a reflected light spectrum is obtained from a sample by using a light source having an arbitrary spectrum, the reflected light spectrum may be processed by using a window function before performing the FFT. By using the signal after the process as the reflected light spectrum, a center of the FFT may be calculated with high accuracy.

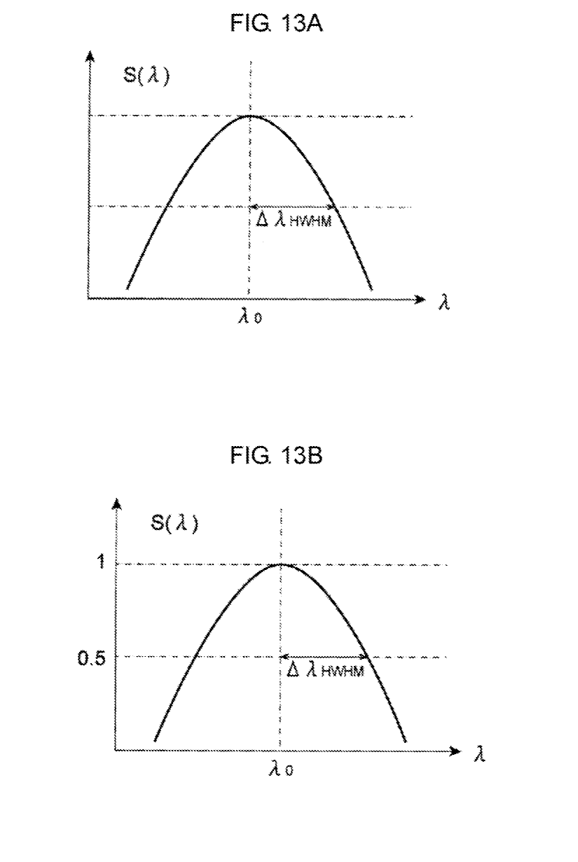

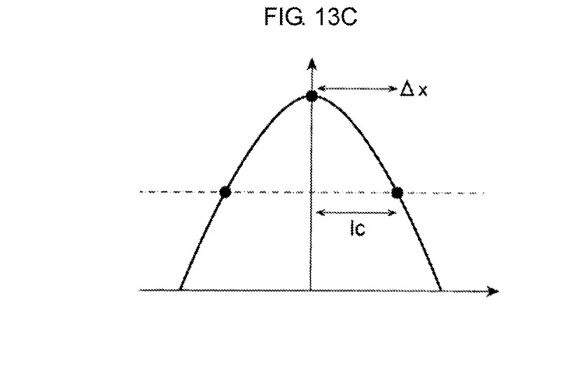

The Gaussian function, for example, may be used as the window function. Hereinafter, an example of the Gaussian function will be described below. The Gaussian function may normalize an area to 1 or may normalize a height to 1. FIG. 13A shows an example of the Gaussian function for normalizing the area to 1. If the central wavelength is λ0 and a half-width at half maximum is Δλ_{HWHM}, the Gaussian function of FIG. 13A is represented by the following equations.

$$\begin{matrix}I ( λ ) = R \{ 1 + {( 1 - R )}^{2} - 2 ( 1 - R ) cos ( 2 n \cdot \frac{2 π}{λ} \cdot d ) \} \cdot S ( λ ) & ( 26 ) \\ S ( λ ) = \frac{1}{{Δλ}_{HWHM}} \cdot \sqrt{\frac{ln 2}{π}} exp [ - {( \frac{λ - {λ}_{0}}{{Δλ}_{HWHM}} )}^{2} ] \cdot ln 2 & ( 27 )\end{matrix}$$

Also, FIG. 138 shows an example of the Gaussian function for normalizing the height to 1. If a central wavelength is λ0 and a half-value and half-width is Δλ_{HWHM}, the Gaussian function of FIG. 13B can be represented by the following equations.

$$\begin{matrix}I ( λ ) = R \{ 1 + {( 1 - R )}^{2} - 2 ( 1 - R ) cos ( 2 n \cdot \frac{2 π}{λ} \cdot d ) \} \cdot S ( λ ) & ( 28 ) \\ S ( λ ) = exp [ - {( \frac{λ - {λ}_{0}}{{Δλ}_{HWHM}} )}^{2} ] \cdot ln 2 & ( 29 )\end{matrix}$$

According to the Gaussian function used as the window function, a waveform is converted so that three sampling points are included in full width at half maximum as shown in FIG. 13C. Thus, the following inequality has to be satisfied.

$$\frac{ln 2}{π} \cdot \frac{{λ}_{0}^{2}}{Δλ} > Δ X = \frac{{λ}_{0}^{2}}{Δ w} \qquad ( 30 )$$

The above inequality may be converted as follows.

$$Δλ < \frac{ln 2}{π} \cdot Δ w \qquad ( 31 )$$

From the inequality (31), when the wavelength range Δw of the measuring range is 40 nm, a light source having a half width at half maximum of 8.8 nm or less is necessary, and thus, the Gaussian function having the half width at half maximum of 8.8 nm or less is set as the window function. Also, if the Gaussian function shown in FIG. 13C is the Gaussian function for normalizing the height to 1 and satisfies the inequality (31), an intensity at the end of the measuring range may be calculated by using the equation (29). That is, if λ−λ₀=20 nm and λ_{HWHM} is 8.8 nm, the intensity is 2.7867×10⁻². As described above, if the intensity at the end of the measuring range is reduced by about 97%, the shape of the 2nd signal after the FFT becomes similar to the Gaussian function. By using the window function, the measuring operation can be performed without regard to the wavelength of the light source, the spectral width, the central wavelength and the bandwidth of the measuring system such as the spectroscope, and the like.

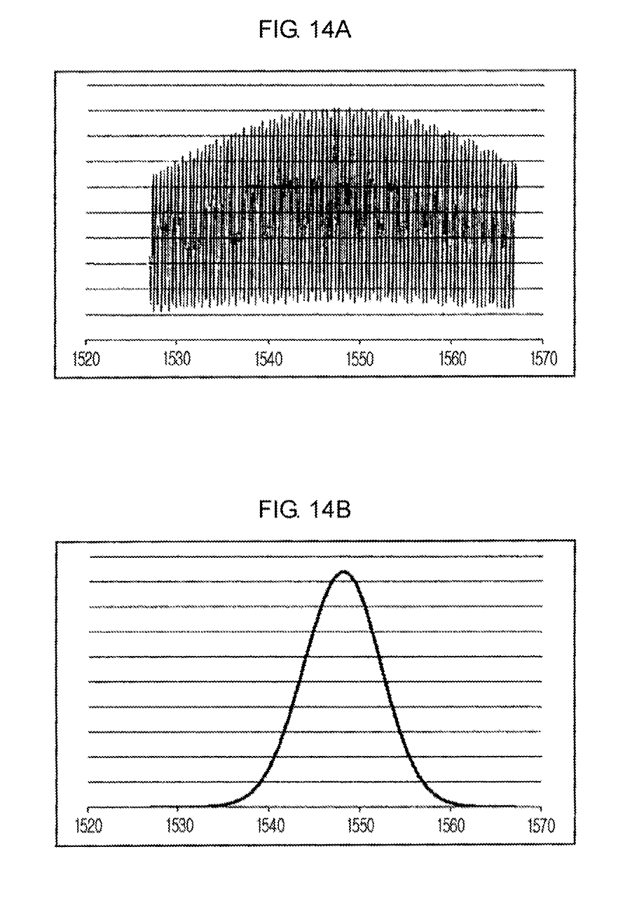

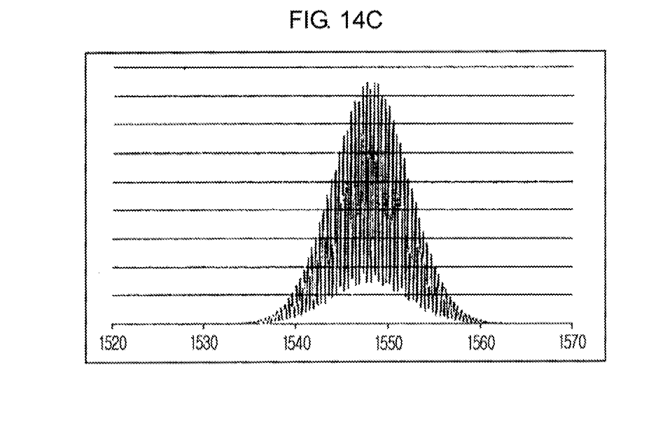

Hereinafter, a case of using the window function will be described in detail below. FIG. 14A shows an example of a reflected light spectrum in a case where the central wavelength λ₀ is 1548 nm, the half width at half maximum is 30 nm, a thickness d of a sample is 775 μm, and a refractive index n of the sample is 3.7. FIG. 14B shows an example of the Gaussian function having a half width at half maximum Δλ_{HWHM} of 5 nm. FIG. 14C shows a signal obtained by applying the Gaussian function of FIG. 14B to the reflected light spectrum of FIG. 14A.

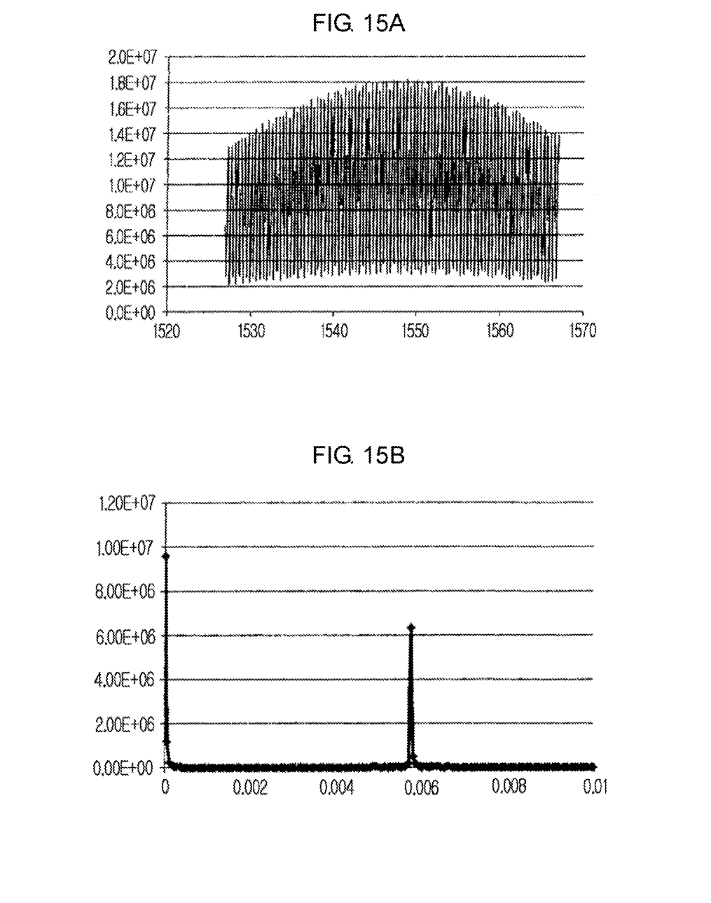

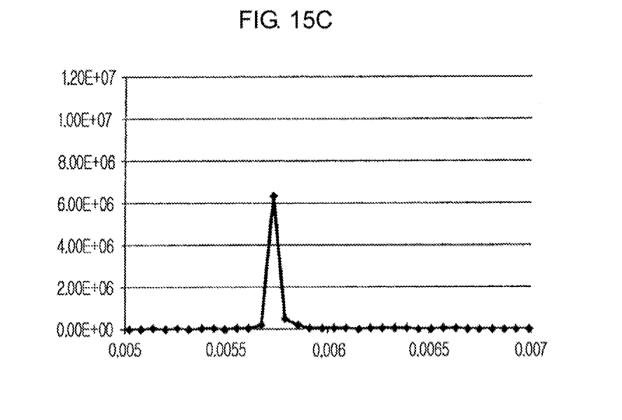

As shown in FIG. 15A (that is, FIG. 14A), a 2nd signal after the FFT when using the reflected light spectrum having the central wavelength λₒ of 1548 nm, the half width at half maximum of 30 nm, a thickness d of a sample of 775 μm, and a refractive index n of the sample of 3.7 is obtained as shown in FIG. 15B. FIG. 15C is an enlarged view of a peak portion in FIG. 15B. As shown in FIG. 15C, since the peak itself is determined only by one sampling point, the accuracy of the center location is degraded.

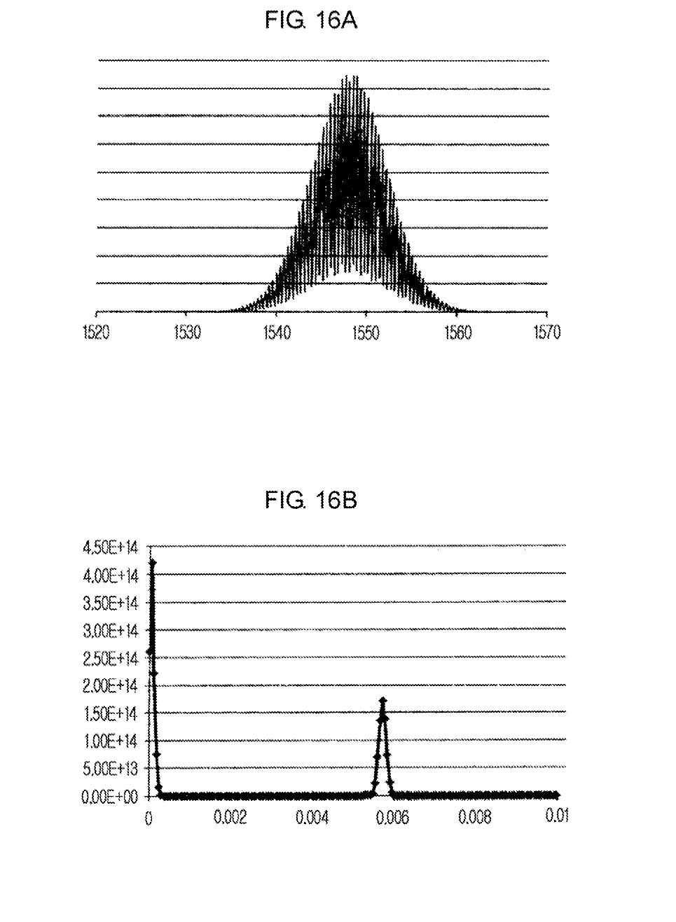

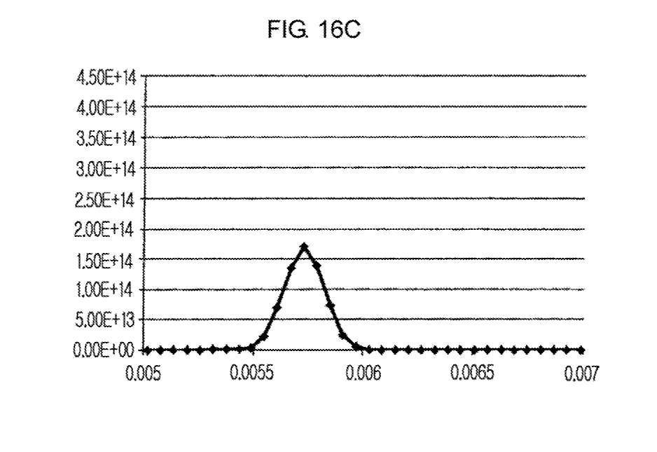

Meanwhile, as shown in FIG. 16A (that is, FIG. 14C), the 2nd signal after the FFT has a peak having a width as shown in FIGS. 16B and 16C by using a signal after the window function is applied. Accordingly, the accuracy of detecting the center location can be improved.

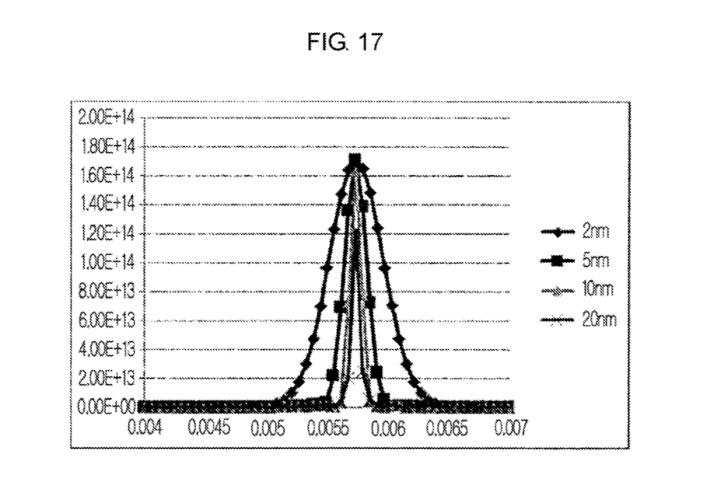

Also, FIG. 17 is a graph for showing a relation between the half width at half maximum Δλ_{HWHM} of the light source and the width of the waveform after the FFT. As shown in FIG. 17, if a size of the half width at half maximum Δλ_{HWHM} of the light source is changed, the width of the waveform of the 2nd after the FFT is changed. As the points forming the peak shape after the FFT is increased, the calculation accuracy of the center is improved. That is, as the half width at half maximum Δλ_{HWHM} of the light source is reduced, the width of the waveform of the 2nd after the FFT may be increased.

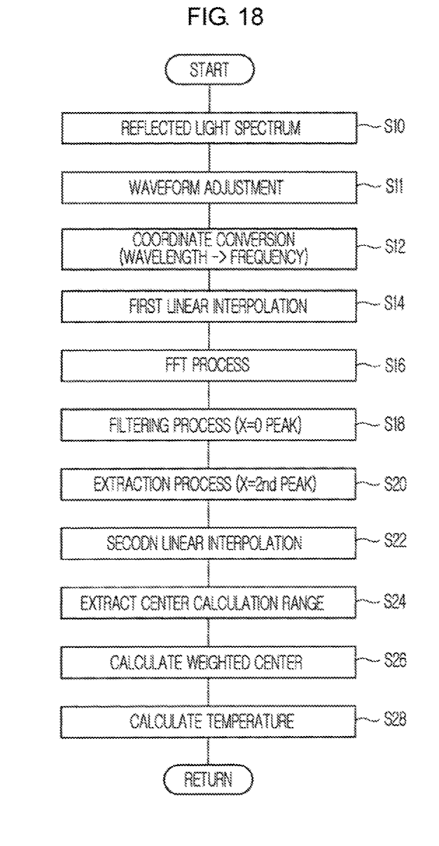

Next, a temperature measuring operation of the interference optical system 1 will be described. FIG. 18 is a flowchart for describing operations of the interference optical system 1, and describes a method of measuring the temperature (a spectrum acquisition operation and a measuring operation). Controlling processes shown in FIG. 18 are repeatedly performed at a predetermined interval from a timing when, for example, the light source 10 and the calculation apparatus 15 are turned on, Also, it is assumed that preliminary setting of the tunable filter 40 is finished. That is, the relation between, for example, the applied voltage (or applied frequency) and the wavelength of the transmitted light as shown in FIG. 3 is acquired in advance.

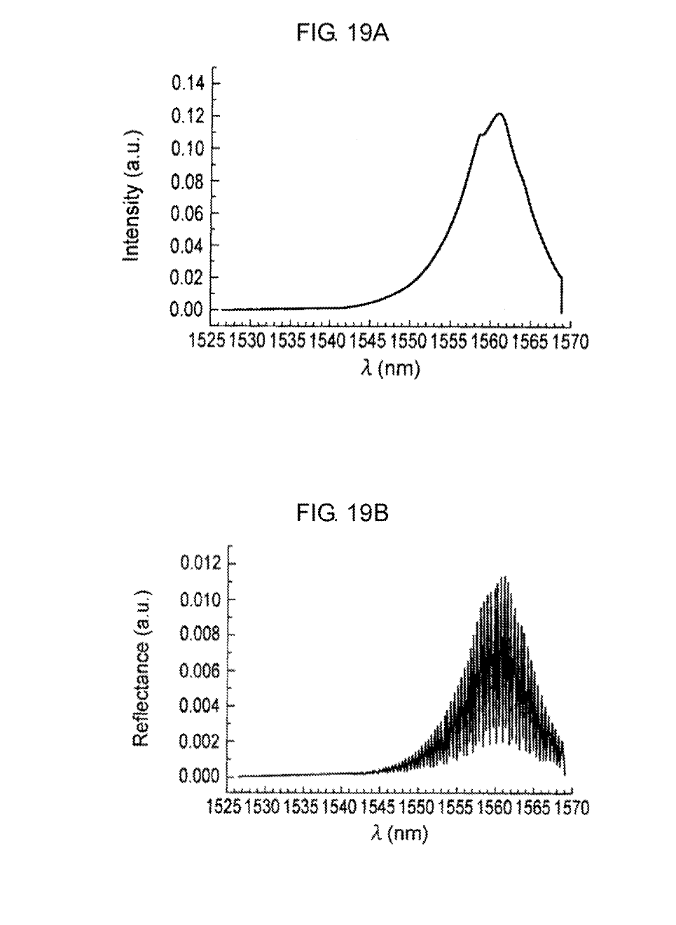

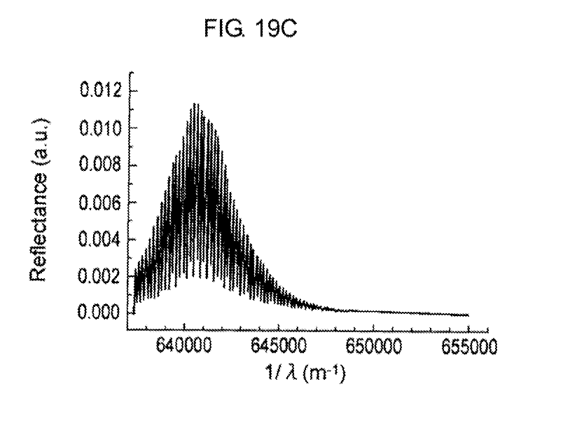

As shown in FIG. 18, this flowchart is started from a process of inputting the reflected light spectrum (S10). The light source 10 generates the measuring light. For example, the measuring light has a spectrum shown in FIG. 19A. The light-receiving element 41 acquires the spectrum of the reflected light from the surface 13a and the rear surface 13b of the object 13. That is, the reflected light is wavelength-swept by the tunable filter 40 and is detected by the light-receiving element 41. Accordingly, the reflected light having the spectrum, for example, as shown in FIG. 19B, is obtained. The spectrum of the reflected light is input to the calculation apparatus 15 from the 51 light-receiving element 41. When the process of S10 ends, the process goes to a waveform adjusting process (S11).

In the operation S11, the waveform adjustment unit 31 adjusts the waveform. That is, the window function described above is applied to the reflected light spectrum. When the operation S11 is finished, the process goes to a coordinate changing process (S12).

In the operation S12, the optical path length calculation unit 16 converts a coordinate axis of the spectrum obtained by the operation S11 to a spatial frequency 1/λ from a wavelength λ. For example, a spectrum shown in FIG. 19C is obtained. When the process of the operation S12 ends, the process goes to a first data interpolation process (S14).

In the operation S14, the optical path length calculation unit 16 performs a data interpolation of the spectrum obtained from the process of S12. For example, the number of samplings is Nₛ, the data is data of the spectrum, spatial frequencies are arranged in an order of x₀, x₁, x₂, . . . , x_{N-1}, and intensities are arranged in an order of y₀, y₁, y₂, . . . , Y_{N-1}. First, the optical path length calculation unit 16 rearranges the spatial frequencies at same intervals. For example, when it is assumed that a spatial frequency included in rearranged spatial frequencies is Xᵢ, the spatial frequencies are rearranged by using the following equation,

$${X}_{i} = {x}_{0} + \frac{{x}_{N - 1} - {x}_{0}}{{N}_{s} - 1} \cdot i \qquad ( 32 )$$

Next, the optical path length calculation unit 16 calculates an intensity of the spatial frequency Xᵢ after the rearrangement by using a linear interpolation. When it is assumed that the intensity at that time is Yᵢ, Yᵢ is calculated by using the following equation.

$${Y}_{i} = \frac{{y}_{j + 1} - {y}_{j}}{{x}_{j + 1} - {x}_{j}} \cdot ( {X}_{i} - {x}_{j} ) \qquad ( 33 )$$

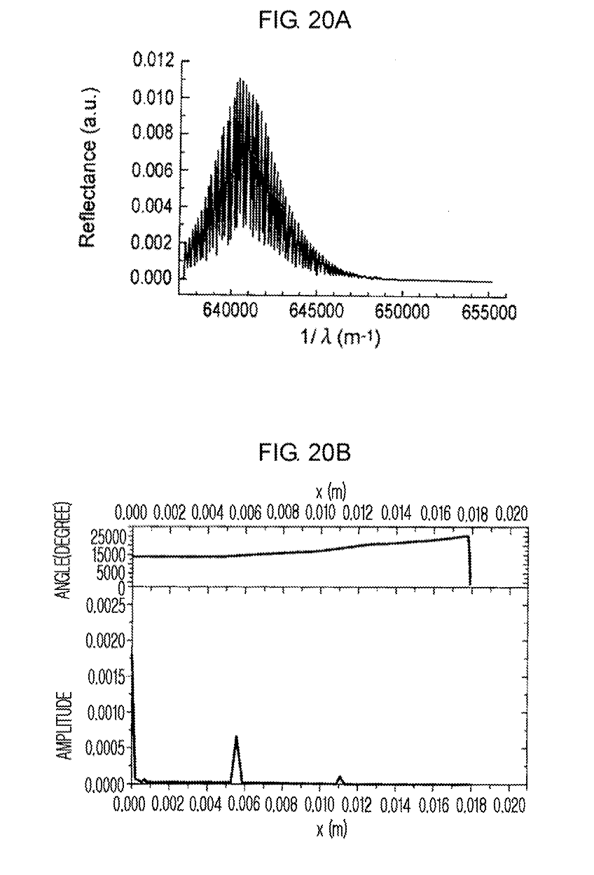

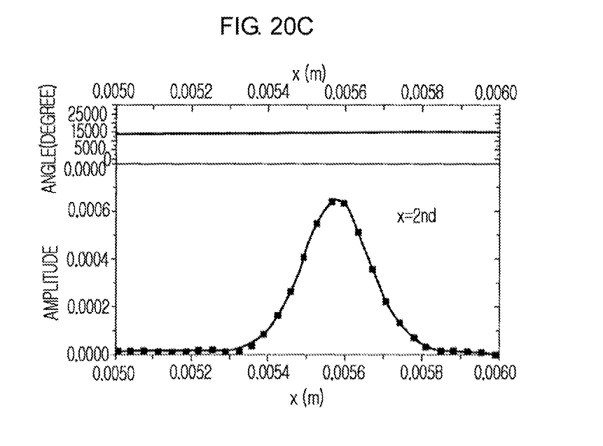

Here, j is a maximum integer satisfying a condition Xᵢ>xⱼ. Accordingly, a spectrum shown in FIG. 20A is obtained. When the process of S14 ends, the process goes to an FFT process (S16).

In the operation S16, the Fourier transformation unit 17 performs Fourier transformation of the spectrum that is interpolated in the operation S14 (Fourier transformation process). Accordingly, for example, as shown in FIG. 20B, a spectrum having a longitudinal axis denoting an amplitude and a transverse axis denoting a phase is obtained. When the operation S16 ends, the process goes to a filtering process (S18).

In the operation S18, the optical path length calculation unit 16 filters a peak value of X=0 from the spectrum obtained by the process performed in the operation S16. For example, 0 is substituted in intensity data Y within a range from X=0 to X=Z (predetermined value). When the process of the operation S18 is finished, the process goes to an extraction process (S20).

In the operation S20, the optical path calculation unit 16 extracts a peak value where X=2nd from the spectrum obtained by the process in the operation S18. For example, when a maximum value of the peak is Y, twenty data points are extracted from a value Yᵢ₋₁₀, in order to extract the data from the center to an end of the peak. For example, when the maximum value of the peak is 1, the data points are extracted from a range from the maximum value to 0.5. For example, a spectrum shown in FIG. 20C is extracted. When the process of the operation S20 is finished, the process goes to a second data interpolation process (S22).

In the operation S22, the data interpolation unit 18 interpolates data of the peak of 2nd obtained in the process of S20 (data interpolation process). The data interpolation unit 18 linearly interpolates, for example, intervals between the data points at constant intervals by the number of interpolations (N). The number of interpolations N_{A} is set in advance based on, for example, necessary temperature accuracy.

Here, the number of interpolations N_{A} is described. For example, when the object 13 is a Si substrate having a diameter of 300 mm, a peak interval λ2nd after the FFT is 0.4 μm/° C. Therefore, when an accuracy of 1° C. is necessary, the number of interpolations N_{A} is set so that the interval between data points becomes 0.4 μm. The number of interpolations N_{A} may be determined in consideration of a noise level of the system. For example, the data interpolation is performed by using the following equation.

$${Y}_{i} = ( {y}_{j + 1} - {y}_{j} ) \cdot \frac{{X}_{i} - {X}_{j}}{{X}_{j + 1} - {X}_{j}} \qquad ( 34 )$$

Here, j is an index used to arrange the intensities. The data interpolation unit 18 executes the above equation 32 within a range of i=0 to N−1. That is, the data interpolation is performed with respect to all of the intervals between the 20 data points obtained from the process of S20. As described above, the data interval after the Fourier transformation is divided into the necessary number (the number of interpolation N), and then, linear interpolation is performed by the number of data according to the number of divisions. When the process of S22 is finished, the process goes to an extraction process (S24).

In the operation S24, the center calculation unit 19 only extracts the data range used to calculate the center from the data interpolated in the process of S22. For example, the center calculation unit 19 substitutes 0 to intensity data (Y) that is less than the maximum intensity (Y_{MAX})×A under an assumption that a threshold value used to the center calculation is A %. When the process of S24 is finished, the process goes to a center calculation process (S26).

In the operation S26, the center calculation unit 19 calculates a weighted center from the data interpolated in the process of the operation S24 (weighted center calculation process). For example, the following equation is used.

$$2 \cdot n \cdot d = \frac{{\sum }_{i = 1}^{N} ( {Y}_{i} \cdot {X}_{i} )}{{\sum }_{i = 1}^{N} {Y}_{i}} \qquad ( 35 )$$

In addition, N denotes the number of data points after extracting the central range. The optical path length nd may be calculated by using the above equation (35). When the process of the operation S26 is finished, the process goes to a temperature calculation process (S28).

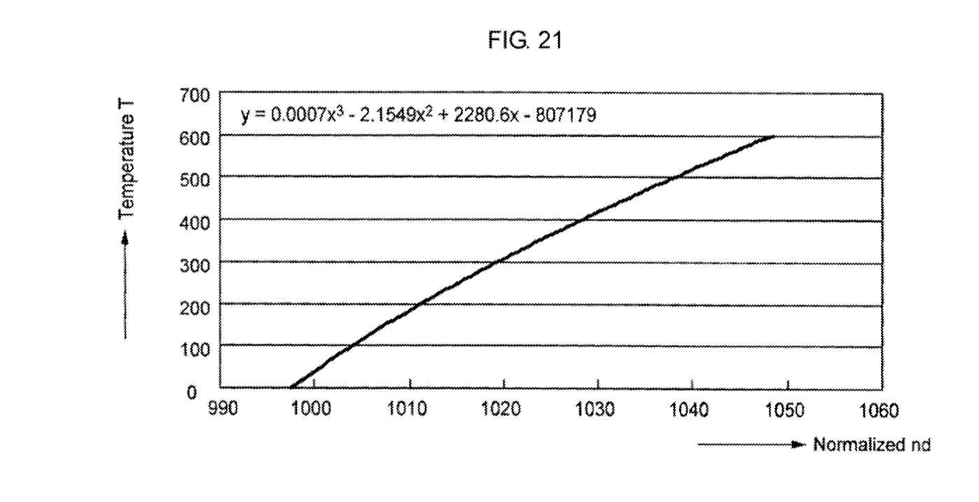

In the operation S28, the temperature calculation unit 20 calculates a temperature by using the optical path length nd obtained in the process of the operation S26 (temperature calculation process). The temperature calculation unit 20 calculates the temperature by using, for example, temperature correction data 21 shown in FIG. 21. In the graph of FIG. 21, a transverse axis denotes the optical path length nd, and a longitudinal axis denotes the temperature. The temperature correction data 21 is acquired in advance with respect to each object 13. Hereinafter, an example of generating the temperature correction data 21 in advance will be described. For example, temperatures are actually measured by using a blackbody furnace. Temperatures T and optical path lengths nd_{T} corresponding to the temperatures T are simultaneously measured. The temperatures T are measured by using a thermometer such as a thermocouple. The optical path lengths nd_{T} are measured by using the above described method of using the FFT. Also, the optical path lengths nd_{T} are normalized under a condition where an optical path length nd₄₀ when a measured value of the thermometer is 40° C. is 1000. In addition, the temperature and the normalized optical path length nd_{T} are approximated at every 100° C. according to a cubic equation to derive a coefficient of an approximate curve. Equation shown on upper left portion of a graph of FIG. 21 is the cubic equation. Also, a function of the normalized optical path lengths nd_{T} depending on the temperatures T is represented by the following equation,

$$f ( T ) = \frac{n \cdot {d}_{T}}{n \cdot {d}_{40}} \qquad ( 36 )$$

In addition, a reversed function of f(T) is represented by the following equation.

$$T = {f}^{- 1} ( \frac{n \cdot {d}_{T}}{n \cdot {d}_{40}} ) \qquad ( 37 )$$

The optical path length nd₄₀ is calculated by the following equation according to both an initial temperature T₀ and an optical path length nd_{T0} at that time.

$$n \cdot {d}_{40} = \frac{n \cdot {d}_{T 0}}{f ( T0 )} \qquad ( 38 )$$

Based on the optical path length nd₄₀ obtained based on the above equation (36) and the optical path length nd_{T}, the temperature T is calculated by using the above equation (35). When the operation S28 ends, the controlling processes shown in FIG. 18 are finished.

As described above, the controlling processes shown in FIG. 18 are finished. By performing the controlling processes of FIG. 18, the reflected spectrum of high accuracy can be obtained by using the Gaussian function while setting the number of samplings in the reflected light spectrum arbitrarily. Also, the temperature can be measured with high accuracy even when there are small amounts of data points. In the data interpolation process, the linear interpolation is performed, and thus, the center location can be determined without depending upon a signal profile after the FFT. In addition, since the data points can be interpolated according to the temperature accuracy, the temperature measurement may be performed accurately and stably.

According to the interference optical system 1 according to the embodiment of the present invention, the wavelength of the light incident to the single light-receiving element 41 is swept by the tunable filter 40. Thus, the number of samplings can be adjusted arbitrarily. Therefore, by increasing the number of samplings within the measured wavelength range, an uppermost value of the measurable film thickness can be easily changed. For example, the uppermost value of the measurable film thickness can be greatly increased. Also, the waveform before the Fourier transformation may be converted into a waveform suitable for the Fourier transformation by using the window function, and thus, the peak of the waveform after the Fourier transformation may have a certain degree of width. Therefore, the accuracy of detecting the peak location can be improved.

Also, the above described embodiments are examples of the interference optical system and an alignment adjusting method, and thus, the device and method according to the embodiments of the present invention may be modified or applied to other fields.

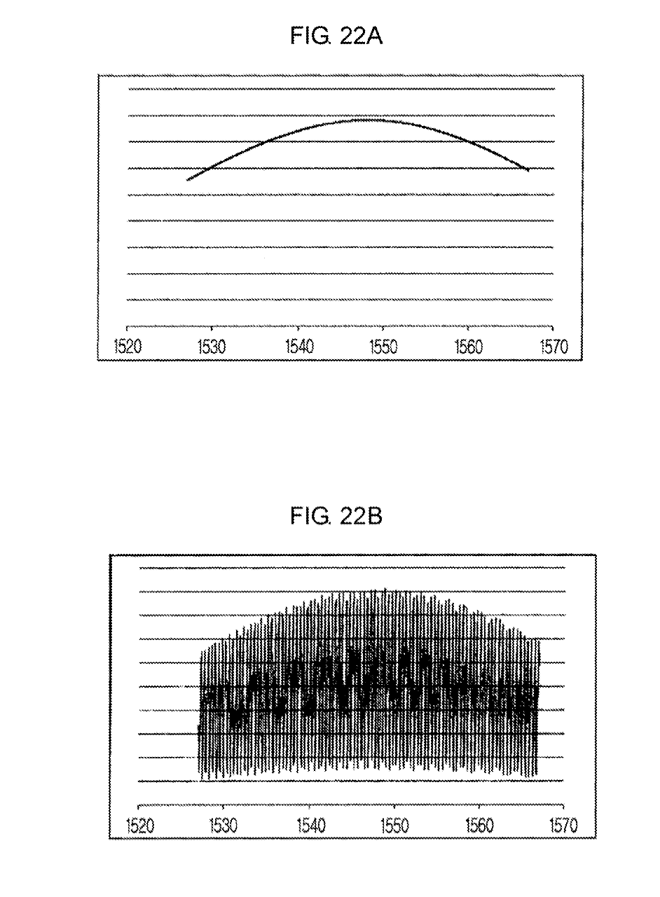

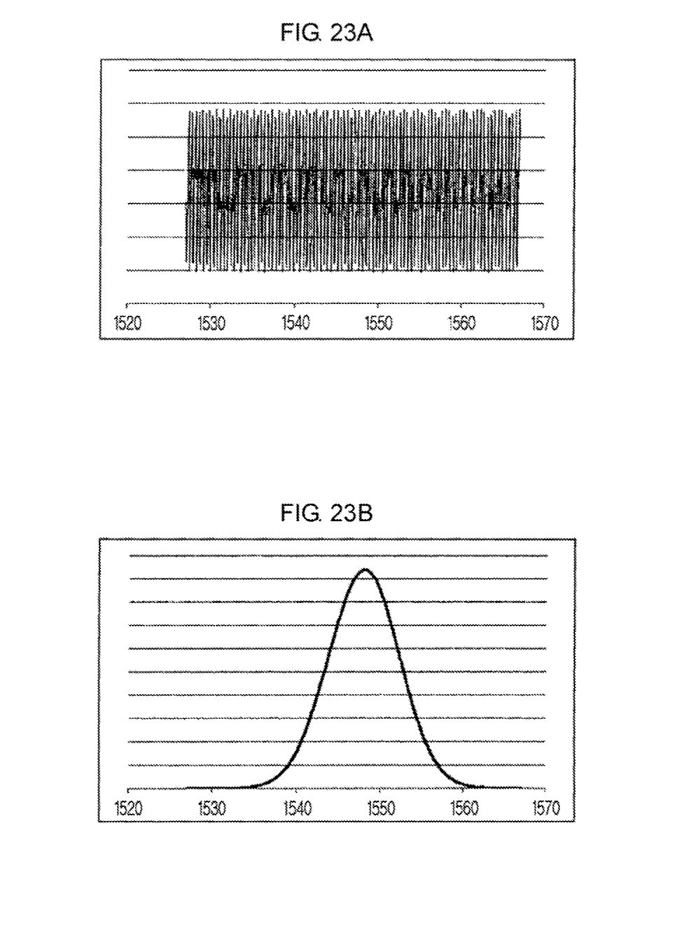

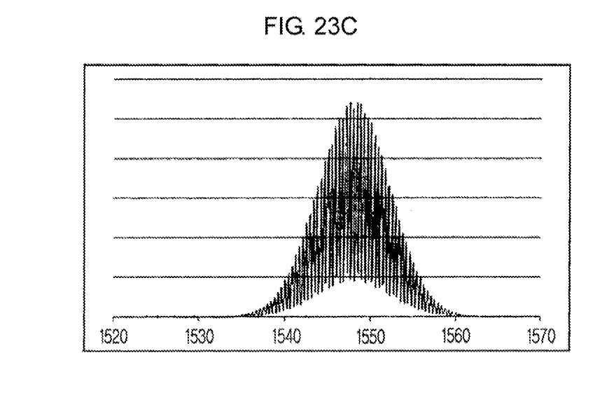

For example, the spectrum of the light source is obtained in advance and recorded before performing the controlling operation shown in FIG. 18, and the reflected light spectrum may be normalized by the normalization unit 30 before the adjustment operation of S11. For example, the light source spectrum shown in FIG. 22A may be acquired in advance. It is assumed that the reflected light spectrum of the Si substrate shown in FIG. 228 is acquired. The normalization unit 30 normalizes the reflected light spectrum by using the light source spectrum. For example, the reflected light spectrum is divided by the light source spectrum to calculate a reflectivity. FIG. 23A shows an example of the spectrum normalized as the reflectivity. When the spectrum shown in FIG. 23A is integrated with the Gaussian function shown in FIG. 238, a spectrum shown in FIG. 23C is obtained. Accordingly, the signal after the FFT is a complete Gaussian function signal.

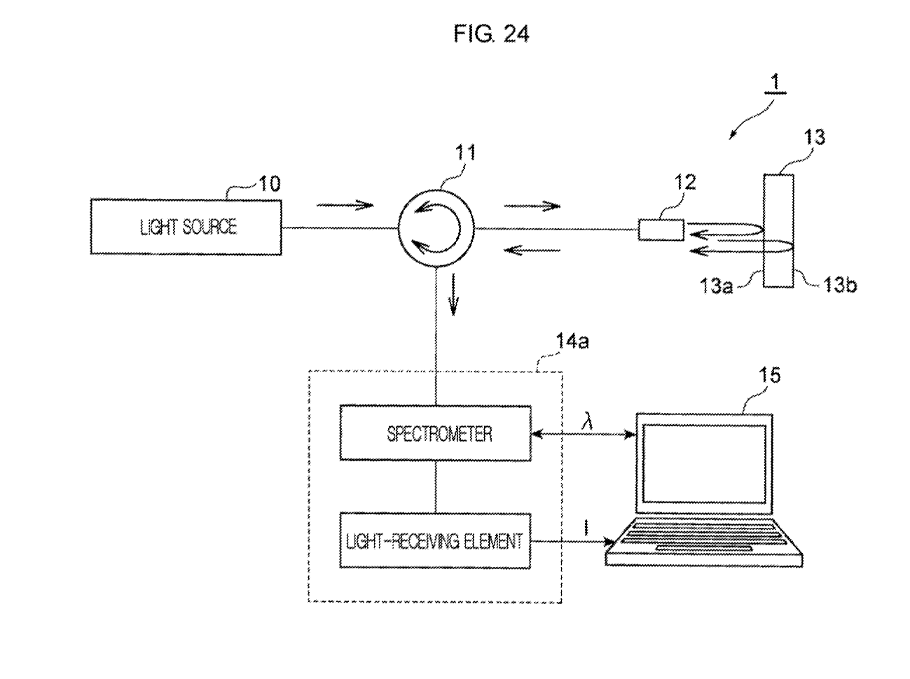

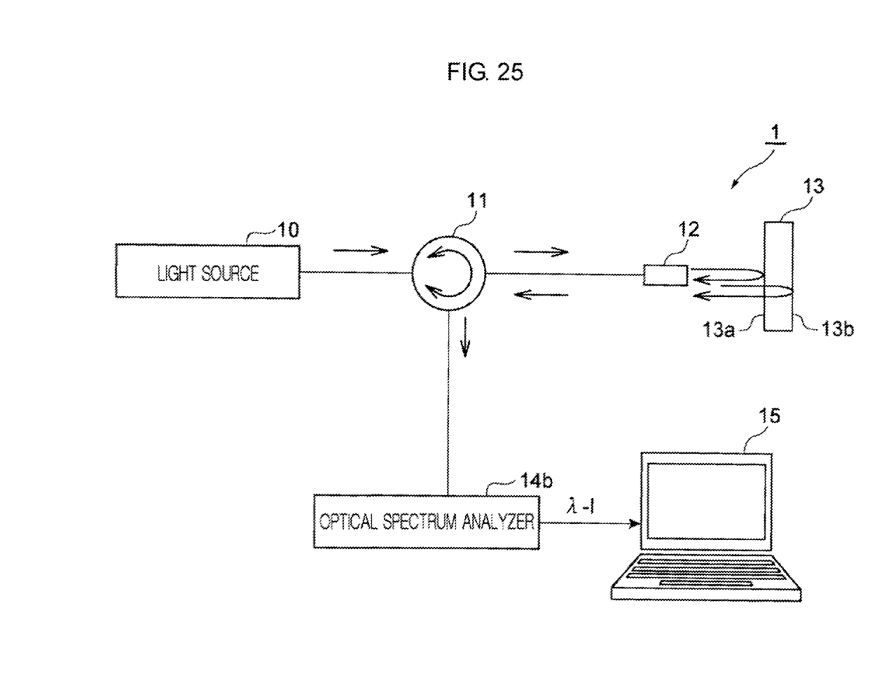

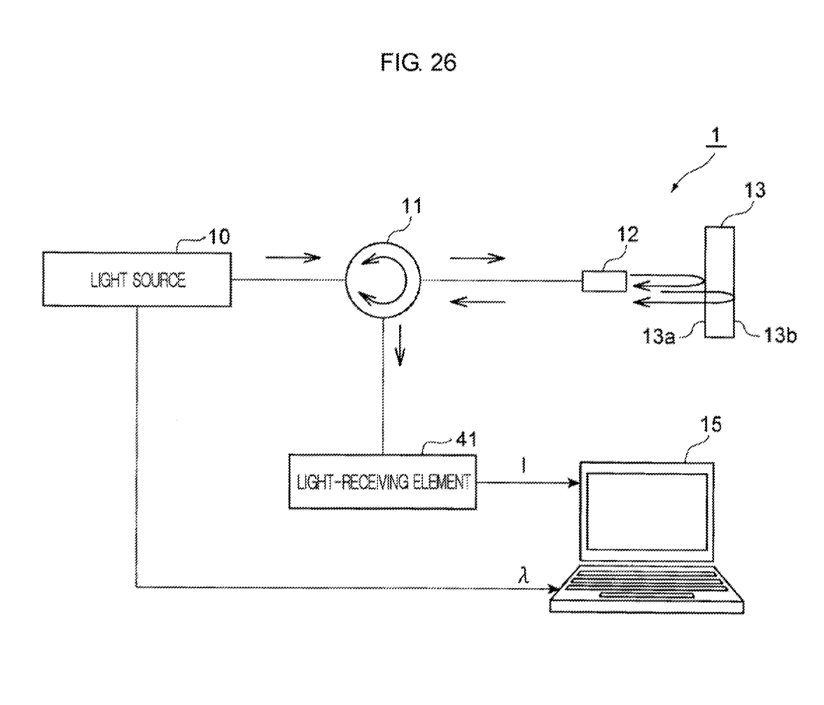

Also, the A/D converter 42 and the wavelength controller 43 shown in FIG. 1 may be included in the calculation apparatus 15. Also, the tunable filter 40 of FIG. 1 may be provided between the light source 10 and the optical circulator 11, or between the optical circulator 11 and the collimator 12. In addition, FIG. 1 shows an example where the tunable filter 40 is used; however, a movable-grating spectroscope may be used. FIG. 24 shows a spectroscope 14a including a movable-grating spectrometer and a single light-receiving element, wherein the calculation apparatus 15 and the spectrometer controls a wavelength λ of the transmitted light in cooperation with each other. Also, as shown in FIG. 25, an optical spectrum analyzer may be used as a movable-grating spectroscope. In this case, a spectrum of a wavelength-intensity may be directly obtained. In addition, as shown in FIG. 26, the calculation apparatus 15 may control the wavelength of the light source 10. For example, the wavelength of the light source 10 may be changed by controlling a temperature. As described above, a unit for sweeping the wavelength may be any of the components.

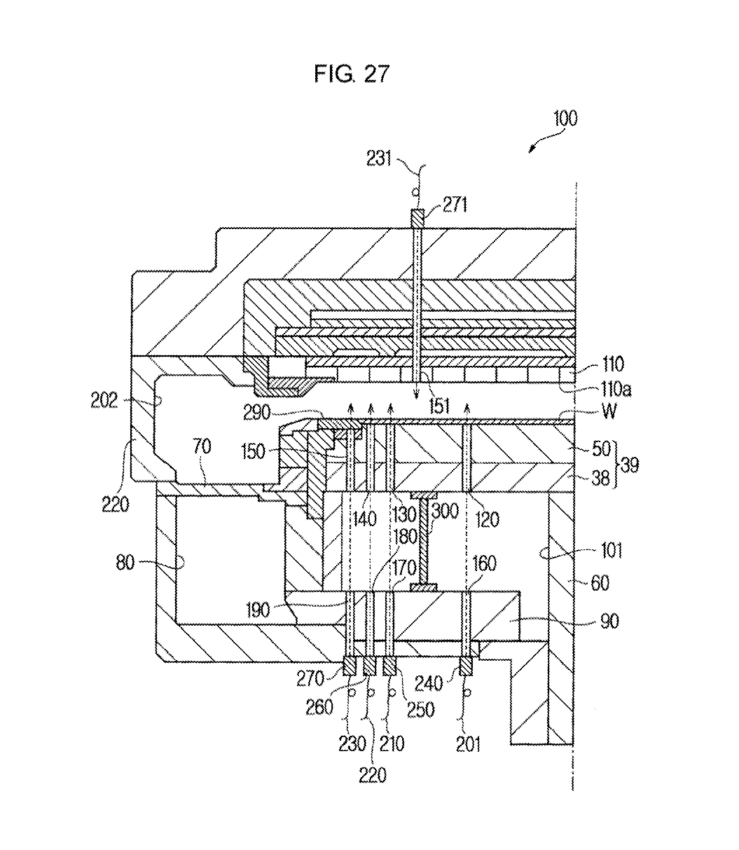

Also, the interference optical system 1 according to the embodiment of the present invention may be mounted in a substrate processing apparatus. FIG. 27 is a schematic longitudinal sectional view showing principal parts of a substrate processing apparatus 100 according to an embodiment of the present invention. Herein, as an example of the object 13 in which a temperature is measured in a substrate processing apparatus such as a plasma etching apparatus, a wafer, a focus ring, or a counter electrode (upper electrode) will be described below.

As shown in FIG. 27, the substrate processing apparatus 100 includes a vacuum chamber 200 for accommodating a semiconductor wafer W, that is, a substrate, and processing the semiconductor wafer W by using plasma.

The vacuum chamber 200 defines a processing chamber 202 therein. The processing chamber 202 is configured to be vacuum exhausted. A holding stage 39 which holds the semiconductor wafer W is provided in the processing chamber 202. The holding stage 39 includes an RF plate 38 formed of a conductive material and to which an RF power is applied, and an electrostatic chuck mechanism 50 which is provided on the RF plate 38 and adsorbs the semiconductor wafer W. In addition, a power feed rod 60 that is electrically connected to an RF power source (not shown) is connected to a center portion of the RF plate 38.

A baffle plate 70 formed as a loop shape to surround the holding stage 39 is provided around the holding stage 39, and an exhaust space 80 of a loop shape is formed under the baffle plate 70 so as to perform exhaustion from around the holding stage 39. Also, a base plate 90 is provided on a bottom portion of the vacuum chamber 200, and a gap 101 is formed between the RF plate 38 and the base plate 90. The gap 101 has an area that is large enough to insulate the RF plate 38 and the base plate 90 from each other. Also, a driving mechanism (not shown) of a pusher pin that picks up the semiconductor wafer W from a transfer arm to place the semiconductor wafer W on the holding stage 39 or lifts the semiconductor wafer W from the holding stage 39 to deliver the semiconductor wafer W to the transfer arm is provided in the gap 101. Also, the gap 101 is not in a vacuum atmosphere, but in an atmospheric pressure.

A counter electrode 110 facing the holding stage 39 is provided above the holding stage 39. The counter electrode 110 is formed of, so-called a shower head, and is configured to supply a predetermined processing gas in a shower type toward the semiconductor wafer W placed on the holding stage 39. The conuter electrode 110 is maintained at a ground potential or a RF electric power is applied to the counter electrode. A focus ring 290 is provided around the semiconductor wafer W on the holding stage 39. The focus ring 290 is formed to improve in-plane uniformity of the plasma process on the semiconductor wafer W.

The vacuum chamber 200 is configured that the gap 101 under the holding stage 29 is in the atmospheric environment and the processing chamber 202 above the holding stage 39 is in the vacuum atmosphere. Therefore, the holding stage 39 configures a part of a partition wall for dividing the vacuum atmosphere and the atmospheric environment. In addition, a plurality of temperature measuring windows 120, 130, 140, 150, and 151 are formed in the holding stage 39. The temperature measuring windows 120, 130, 140, and 150 are optically communicated such that measuring light may transmit through upper and lower surfaces of the holding stage 39, and are air-tightly sealed. The temperature measuring window 151 is formed on an upper portion of the vacuum chamber 200 downward, and is optically communicated and air-tightly sealed.

In the embodiment of the present invention, among the temperature measuring windows 120, 130, 140, 150, and 151, the temperature measuring window 150 that is provided at the outermost circumferential side of the holding stage 39 is to measure a temperature of the focus ring 290, and the other temperature measuring windows 120, 130, 140, and 151 are to measure a temperature of the semiconductor wafer W or a temperature of the counter electrode 110.

Penetration holes 160, 170, 180, and 190 are provided in the base plate 90 to correspond to the temperature measuring windows 120, 130, 140, and 150, and collimators 240, 250, 260, and 270 that are provided at outlet portions of optical fibers 201, 210, 220, and 230 for guiding the measuring light from the temperature measuring system are fixed at the penetration holes 160, 170, 180, and 190. A connection member 300 connecting the base plate 90 and the holding stage 39 (the RF plate 38) to each other is disposed on the gap 101 between the base plate 90 and the holding stage 39 (RF plate 38). In addition, a penetration hole is provided to correspond to the temperature measuring window 151, and a collimator 271 that is provided at an outlet portion of an optical fiber 231 for guiding the measuring light from the measuring system is fixed at the penetration hole. Although FIG. 27 shows only one connection member 300, a plurality of (for example, four or more) connection members 300 are disposed along a circumference direction. The connection members 300 are formed to prevent transformation or vibration of the holding stage 39.

The optical fibers 201, 210, 220, 230, and 231 are connected to the interference optical system 1 shown in FIG. 1. That is, the collimators 240, 250, 260, 270, and 271 correspond to the collimator 12 of FIG. 1.

A light source may be any kind of a light source, provided that interference between measuring light and reference light can be measured. When a temperature of is the semiconductor wafer W is measured, the light reflected from at least a distance between a surface and a rear surface of the semiconductor wafer W (in general, about 800 to 1500 μm) may not cause interference. In detail, for example, low coherence light may be used. The low coherence light is light having a short coherence length. A central wavelength of the low coherence light is about, for example, 0.3 to 20 μm, and more preferably, about 0.5 to 5 μm. Also, the coherence length may be, for example, 0.1 to 100 μm, and more preferably, about 3 μm or less. When the low coherence light is used as the light source, obstacles caused by unnecessary interference can be avoided, and accordingly, the interference between the reference light and the reflected light from the surface of the semiconductor wafer W or inner layers can be easily measured.

The light source emitting the low coherence light may include, for example, a super luminescent diode (SLD), a light emitting diode (LED), a high luminescent lamp (a tungsten lamp, a xenon lamp, or the like), a super-wide bandwidth wavelength light source, and the like. Among those, an SLD (for example, having a wavelength of 1300 nm) of a high luminance may be used as the light source.

In the interference optical system 1, the reference light is output from the collimators 240, 250, 260, 270, and 271, and is output from the holding stage 39 toward the semiconductor wafer W, the focus ring 290, and the counter electrode 110 that are the objects.

As described above, by mounting the interference optical system 1 in the substrate processing apparatus 100, the thicknesses and temperatures of the wafer W, the focus ring 290, and the counter electrode 110 can be measured. Also, if parts accommodated in a chamber, for example, the focus ring 290 or the counter electrode 110 accommodated in the processing chamber, are objects to be measured, the parts needs to be formed of a material transmitting the measuring light. For example, the parts in the chamber may be formed of, for example, silicon, quartz, or sapphire.

In the above embodiment, the optical circulator 11 is provided; however, 2×1 or 2×2 photo couplers may be used. When using the 2×2 photo couplers, a reference mirror may not be provided.

In the above embodiment, the substrate processing apparatus 100 includes a plurality of collimators; however, only one collimator may be provided.

In the above embodiment, the interference optical system 1 measures the temperature of the object 13; however, a thickness of the object may be measured by using the optical path length nd.

### EMBODIMENTS

Hereinafter, comparative example and embodiment executed by the present inventor will be described below for describing the above effects.

First, a reflected light spectrum is acquired by using the interference optical system 1 of FIG. 1. The Super Luminescent Diode DL-CS5107A (S/N: 0919QZ1000K) manufactured by DenseLight, Corp. was used as the light source. Input current was 120 mA, and the operation was performed at a temperature of 25° C. An output of the light source was 1.5 mW, a center wavelength was 1568 nm, and a spectrum width FWHM was 60 nm. The number of samplings N was 1024.

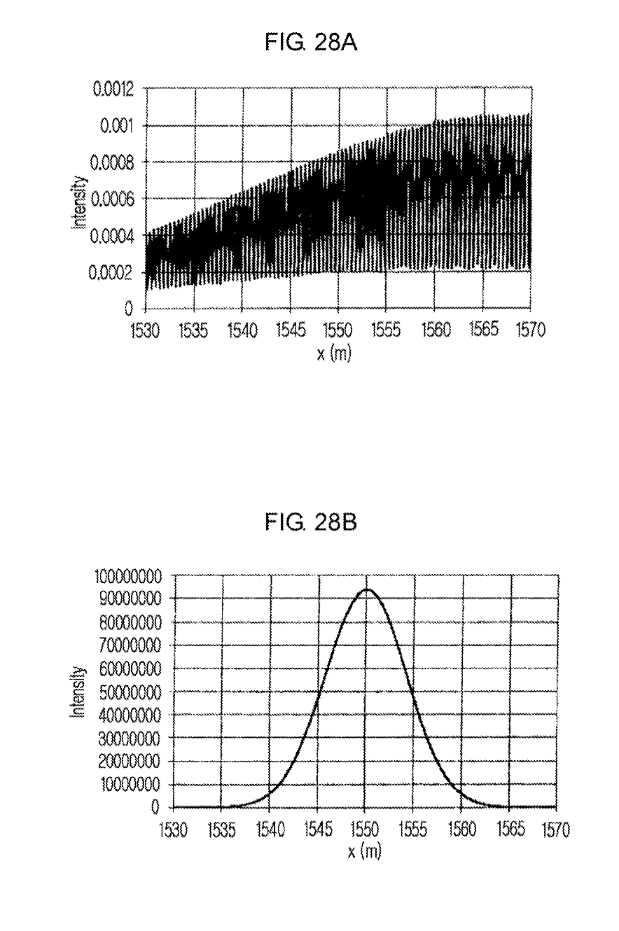

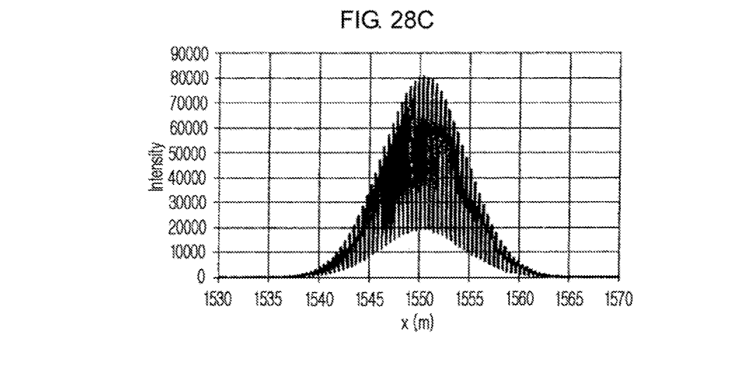

FIG. 28A shows a result.

### Embodiment 1

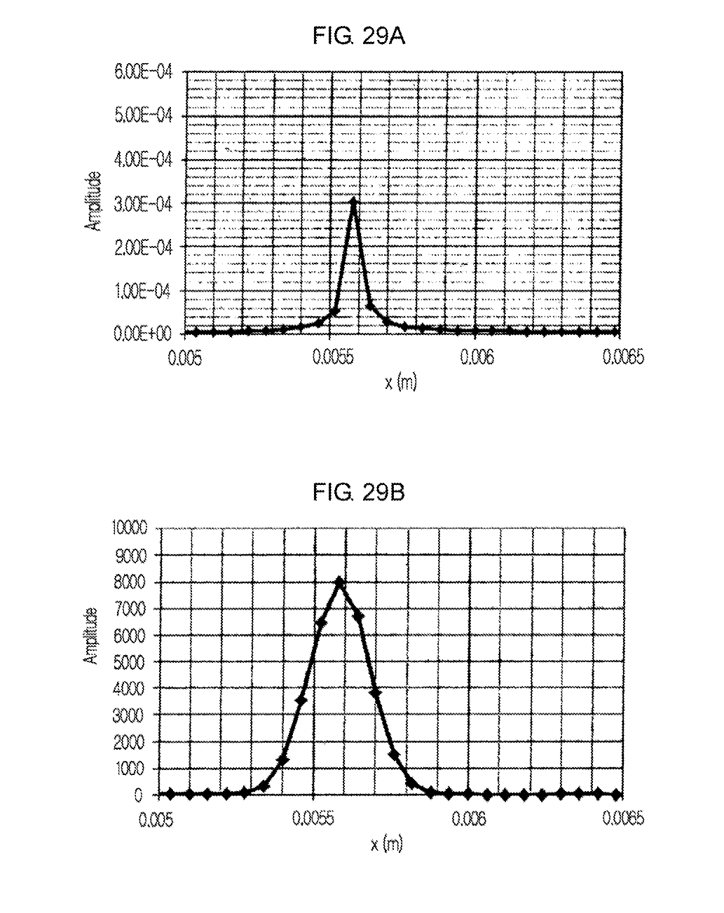

The reflected light spectrum was adjusted by using a Gaussian function shown in FIG. 288. A waveform after the adjustment is shown in FIG. 28C. Then, an FFT was performed, and a result is shown in FIG. 29B.

### Comparative Example 1

The FFT is performed with respect to the reflected light spectrum shown in FIG. 28A, and the result is shown in FIG. 29A.

As shown in FIG. 29A, it is difficult to obtain a center location of a peak according to the comparative example 1, whereas it is easy to calculate the center location as shown in FIG. 298 by using the window function.

As described above, according to the aspects and the embodiments of the present invention, the interference optical system capable of changing the uppermost limit of the measurable film thickness easily, the substrate processing apparatus, and the measuring method are provided.

While this invention has been particularly shown and described with reference to is exemplary embodiments thereof, it will be understood by those skilled in the art that various changes in form and details may be made therein without departing from the spirit and scope of the invention as defined by the appended claims.

What is claimed is:

1. An interference optical system for measuring a thickness or a temperature of an object which has a first main surface and a second main surface opposite to the first main surface, the interference optical system comprising:
a light source which emits measuring light having a wavelength transmitting through the object;
a collimator which is connected to the light source to emit the measuring light from the light source to the first main surface of the object, and receive reflected light from the first main surface and the second main surface;
a single light-receiving element which receives the light from the collimator to obtain an intensity of the light;
a sweeping unit which sweeps a wavelength of the light incident to the light-receiving element;
is a spectrum acquisition unit which measures an interference intensity distribution that has wavelength dependence and is an intensity distribution of the reflected light from the first main surface and the second main surface, by using the sweeping unit and the light-receiving element; and
a measuring unit which measures the thickness or the temperature of the object based on a waveform obtained by Fourier transforming the interference intensity distribution.

2. The interference optical system of claim 1, wherein the sweeping unit is a filter capable of changing the wavelength of the measuring light or the reflected light.

3. The interference optical system of claim 1, wherein the sweeping unit controls the wavelength of the measuring light or the reflected light by using a diffractive grating.

4. The interference optical system of claim 1, wherein the sweeping unit changes a wavelength of the light source.

5. The interference optical system of claim 1, wherein the measuring unit applies a window function to the interference intensity distribution, the window function having wavelength dependence and being a bell-shaped window function which has a peak at a central wavelength determined by a wavelength sweep range of the sweeping unit and which is gradually decreased as being apart from the central wavelength, and measures the thickness or the temperature of the object based on a waveform obtained by Fourier transforming the interference intensity distribution after applying the window function.

6. The interference optical system of claim 5, wherein the measuring unit normalizes the interference intensity distribution by using an intensity distribution of the measuring light from the light source, which is acquired in advance, before applying the window function.

7. The interference optical system of claim 5, wherein the window function is a Gaussian function.

8. The interference optical system of claim 5, wherein the window function is a Lorentz function.

9. The interference optical system of claim 5, wherein the window function is a combined function of a Gaussian function and a Lorentz function.

10. A substrate processing apparatus comprising:
an interference optical system for measuring a thickness or a temperature of an object which has a first main surface and a second main surface opposite to the first main surface; and
a processing chamber which is configured to be vacuum exhausted and accommodates the object,
wherein the interference optical system comprises:
a light source which emits measuring light having a wavelength transmitting through the object;
a collimator which is connected to the light source to emit the measuring light from the light source to the first main surface of the object, and receive reflected light from the first main surface and the second main surface;
a single light-receiving element which receives the light from the collimator to obtain an intensity of the light;
a sweeping unit which sweeps a wavelength of the light incident to the light-receiving element;
a spectrum acquisition unit which measures an interference intensity distribution that has wavelength dependence and is an intensity distribution of the reflected light from the first main surface and the second main surface, by using the sweeping unit and the light-receiving element; and
a measuring unit which measures the thickness or the temperature of the object based on a waveform obtained by Fourier transforming the interference intensity distribution.

11. A measuring method for measuring a thickness or a temperature of an object which has a first main surface and a second main surface opposite to the first main surface, by using an interference optical system, wherein the interference optical system comprises:
a light source which emits measuring light having a wavelength transmitting through the object;
a collimator which is connected to the light source to emit the measuring light from the light source to the first main surface of the object, and receive reflected light from the first main surface and the second main surface;
a single light-receiving element which receives the light from the collimator to obtain an intensity of the light; and
a sweeping unit which sweeps a wavelength of the light incident to the light-receiving element,
wherein the measuring method comprises:
a spectrum acquiring operation, in which a wavelength of the light incident to the light-receiving element is swept by the sweeping unit and an interference intensity distribution that has wavelength dependence and is an intensity distribution of the reflected light from the first main surface and the second main surface is measured; and
a measuring operation which measures the thickness or the temperature of the object based on a waveform obtained by Fourier transforming the interference intensity distribution.
